(19) United States
(12) Patent Application Publication
(10) Pub. No.: US 2026/0289143 A1
(43) Pub. Date: Sep. 24, 2026

(54) SYSTEM

(71) Applicant: SoftBank Group Corp., Tokyo (JP)

(72) Inventor: Hikaru SHOJI, Tokyo (JP)

(73) Assignee: SoftBank Group Corp., Tokyo (JP)

(21) Appl. No.: 19/563,007

(22) Filed: Mar. 11, 2026

(30) Foreign Application Priority Data
Mar. 19, 2025 (JP) 2025-044545

(51) Int. Cl. G06F 40/35; G06F 40/211; G06F 40/268; G06F 40/40; G06N 3/0475

(52) U.S. Cl. CPC G06F 40/35; G06F 40/211; G06F 40/268; G06F 40/40; G06N 3/0475

(57) ABSTRACT

A system includes a processor that is configured to receive a question from a user, analyze the received question by using natural language processing to identify an intention and a content of the question, and generate a prompt based on a result of the analysis, the prompt being configured to instruct a generative AI model to generate a specific question, and input the prompt into the generative AI model so as to generate, by the generative AI model, an additional question that deepens user thinking.

### CROSS-REFERENCE TO RELATED APPLICATION

This application is based on and claims priority under 35 USC 119 from Japanese Patent Application No. 2025-044545 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional dialog systems and question answering systems are typically designed to provide direct answers to user questions as quickly and accurately as possible. While such systems are effective for information retrieval, they do not actively promote deeper thinking, self-reflection, or hypothesis formation by the user. In educational settings, training environments, and creative ideation support, there is a need for dialog systems that do not simply supply answers, but instead guide the user to explore underlying mechanisms, reasons, and concepts through interactive questioning.

However, existing systems that attempt to support reflective learning or Socratic-style dialogue are often rule-based and rigid, and they require significant manual design of question templates and dialogue trees. As a result, these systems are difficult to scale to diverse domains and cannot flexibly adapt to the specific content and intention of an arbitrary user question. In addition, conventional systems do not effectively leverage generative AI models to automatically create follow-up questions tailored to the user's input and to the semantic structure of the question.

Therefore, there is a demand for a system that: (i) receives a natural language question from a user, (ii) analyzes the intention and content of the question, and (iii) automatically generates prompts for a generative AI model so as to produce additional questions that deepen the user's thinking, rather than merely providing direct answers. Such a system should flexibly support a wide range of topics and promote active cognitive engagement by the user.

### SUMMARY

In order to solve the above-described problems, a system according to one aspect of the present invention comprises a processor, wherein the processor is configured to receive a question from a user, analyze the received question by using natural language processing to identify an intention and a content of the question, and generate a prompt based on a result of the analysis. The prompt is configured to instruct a generative AI model to generate a specific question, and the processor is further configured to input the prompt into the generative AI model so as to generate, by the generative AI model, an additional question that deepens user thinking.

In one embodiment, the processor is configured to input the prompt into the generative AI model and cause the generative AI model to generate the question in natural language. By using a generative AI model, the system can flexibly create follow-up questions that are semantically aligned with the user's original question and that encourage the user to consider mechanisms, reasons, or alternative perspectives, without relying solely on fixed templates.

In another embodiment, the processor is configured to present the generated additional question to the user. By presenting the additional question through a user interface of a terminal, the system prompts the user to formulate their own explanation or hypothesis before any final answer is provided. As a result, the system guides the user through an iterative process of reflection and reasoning, thereby facilitating deeper understanding and learning.

The term “system” refers to an arrangement of one or more hardware and/or software components, including at least one processor, that are configured to cooperate to perform the functions described in the claims.

The term “processor” refers to any hardware element or combination of hardware elements capable of executing instructions, including but not limited to a central processing unit (CPU), a graphics processing unit (GPU), a digital signal processor (DSP), a microcontroller, or a programmable logic device, and may represent a single device or multiple devices operating together.

The term “user” refers to any human operator or entity that provides input to the system and receives output from the system through a user interface.

The term “question” refers to a natural language or machine-readable expression input by the user, which is intended to request information, clarification, explanation, or guidance from the system.

The term “natural language processing” refers to a set of computational techniques and algorithms for analyzing, interpreting, and processing text or speech expressed in human languages, including operations such as tokenization, parsing, semantic analysis, intent detection, and entity recognition.

The term “intention” refers to an inferred purpose, goal, or communicative intent behind the user's question, such as seeking a definition, an explanation of mechanisms, a cause, an effect, or an opinion.

The term “content of the question” refers to semantic information contained in the user's question, including topics, entities, relationships, and contextual details expressed by the user.

The term “analysis result” refers to data generated by the natural language processing of the user's question, including identified intention, extracted content, and any structured representation derived from the question.

The term “prompt” refers to a text or structured input generated by the processor, which is designed to be provided to a generative AI model in order to instruct or guide the generative AI model to produce a specific output.

The term “generative AI model” refers to a machine learning model, such as a large language model or other generative model, that is configured to generate text or other data in response to an input prompt, based on parameters learned from training data.

The term “specific question” refers to a question that the generative AI model is instructed to generate according to the prompt, such question being tailored to the intention and content identified from the user's original question.

The term “additional question” refers to a question generated by the generative AI model, under control of the prompt, which is distinct from the user's original question and is intended to further explore or elaborate on the topic introduced by the original question.

The term “deepens user thinking” refers to an effect whereby the additional question encourages the user to reflect further, consider underlying reasons or mechanisms, or expand their reasoning beyond the initial level expressed in the original question.

The term “input the prompt into the generative AI model” refers to the operation in which the processor provides the prompt as an input signal or data structure to the generative AI model so that the generative AI model processes the prompt and produces an output.

The term “generate the question in natural language” refers to the operation in which the generative AI model outputs a question expressed in a human language such as English or Japanese, as opposed to a purely symbolic or numerical representation.

The term “present the generated additional question to the user” refers to the operation in which the processor causes the additional question to be displayed, rendered, or otherwise communicated to the user via a terminal, user interface, or output device.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

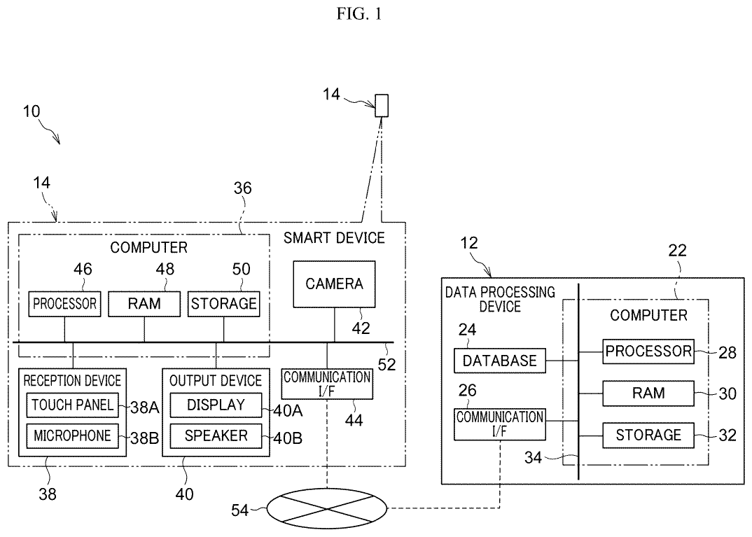

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

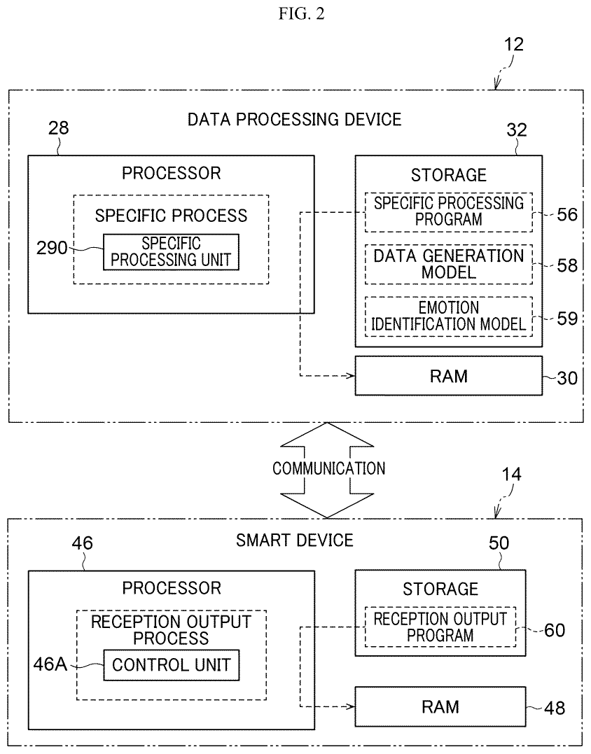

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional dialogue systems that utilize natural language processing and machine learning generally focus on providing direct answers to user questions as quickly and accurately as possible. While such systems may improve response speed and accuracy, they frequently generate output in a one-shot, answer-oriented manner and do not effectively support iterative, reflective thinking by the user. As a result, these systems tend to reduce the user's role to that of a passive recipient of information, and they do not exploit the full potential of conversational interaction to deepen the user's understanding.

From a computer-technology perspective, existing architectures typically treat a generative artificial intelligence model as a black-box answer engine: the server simply forwards the user's question as input and returns the model's output as an answer. In such architectures, there is no dedicated mechanism in the server for (i) analyzing the intent and structure of the user's question in a structured way, (ii) converting the analysis into a prompt sentence that explicitly constrains the behavior of the generative model toward “follow-up question generation” instead of “answer generation,” and (iii) post-processing the generated text to enforce interrogative form and dialog suitability. Consequently, known systems do not provide a technical framework that reconfigures the generative model interaction pipeline itself to optimize for generating question sequences that deepen user thinking.

Moreover, conventional systems often lack fine-grained control over the generative model's output type at the system level. Without such control, the server cannot reliably prevent the model from returning direct answers, cannot guarantee that the output is a question sentence, and cannot systematically filter or normalize the output before presentation. This results in unstable conversation flows, inconsistent user experience, and increased server-side complexity for error handling. These issues are not merely usability problems but also technical deficiencies in the way server-side components orchestrate natural language analysis, prompt construction, and model interaction.

Accordingly, there is a need for an improved computer-implemented technique in which a server, equipped with a processor, is specifically configured to (a) receive and structurally analyze user questions, (b) generate prompt sentences that encode operational constraints for a generative AI model to produce follow-up questions that promote user reflection, and (c) perform post-processing and presentation control so that the generated questions can be iteratively used in a dialog interface. Such a configuration should enhance the overall behavior of the dialogue system as a computing system, by improving controllability, reliability, and consistency of generative outputs, and by enabling a new mode of interaction in which the server systematically guides the generative model toward deepening user thinking rather than merely answering.

The specific processing by the specific processing unit 290 of the data processing device 12 in Example 1 is realized by the following means.

The present invention provides a server comprising a processor configured to receive, from a user via a terminal device, a question expressed in natural language as digital character information; perform natural language processing on the question, including at least morphological analysis, syntactic analysis, and contextual understanding, to identify an intent and elements of the question and generate analysis information; generate, based on the analysis information, a prompt sentence including operation conditions and output conditions for a generative artificial intelligence model so as to cause the generative artificial intelligence model to generate, in natural language, an additional question that deepens the user's thinking, and generate inquiry data including the prompt sentence for input to the generative artificial intelligence model; transmit the inquiry data to the generative artificial intelligence model via a communication path and acquire, from the generative artificial intelligence model, the additional question expressed in natural language and output in response to the prompt sentence; perform post-processing on the additional question, including at least determining that the additional question is an interrogative sentence, normalizing a format of the additional question, and filtering contents of the additional question, to generate presentation question data; and transmit the presentation question data to the terminal device to cause the additional question to be presented to the user via the terminal device. This enables the server to technically restructure the interaction with the generative artificial intelligence model from an answer-oriented pipeline to a question-generation pipeline, thereby improving control over the type and form of generated text at the system level, stabilizing dialog flow, and providing an iterative computer-implemented dialog mechanism that reliably produces follow-up questions optimized to deepen user thinking.

The term “processor” refers to a hardware or virtual computation unit, such as a central processing unit or a processing core in a computing instance, that executes machine-readable instructions to perform the operations described in the present specification.

The term “user” refers to a human operator who interacts with the system by inputting natural language questions and receiving generated questions via a terminal device.

The term “terminal device” refers to an electronic apparatus, such as a computing device having an input interface, a display interface, and a communication interface, that transmits user input to a server and presents output received from the server to the user. The term “question expressed in natural language” refers to a sequence of characters or tokens that forms an interrogative utterance in a human language and is interpretable as a request for information, clarification, or explanation.

The term “digital character information” refers to data representing a sequence of characters encoded in a digital format suitable for processing by electronic circuitry, including, for example, text encoded in a character set.

The term “natural language processing” refers to a series of computational operations applied to natural language text, including one or more of morphological analysis, syntactic analysis, semantic analysis, and contextual analysis, to derive structural or semantic information from the text.

The term “morphological analysis” refers to a computational process of segmenting a text into minimal linguistic units and assigning attributes such as part of speech or base form to each unit.

The term “syntactic analysis” refers to a computational process of determining syntactic structure of a text, including relationships among words or phrases, such as dependency relations or phrase structure.

The term “contextual understanding” refers to a computational process of interpreting a text by considering surrounding words, prior dialogue turns, or other contextual information to infer meaning or intent that is not apparent from isolated words alone.

The term “intent” refers to a logical representation of a purpose or goal underlying a user's question, such as a request for an explanation, a definition, a comparison, or an opinion.

The term “elements of the question” refers to structural or semantic components of a question, including, for example, subject terms, object terms, predicates, keywords, and modifiers extracted during natural language processing.

The term “analysis information” refers to data generated as a result of natural language processing of a question, including at least an identified intent, extracted elements, and any intermediate representations used for subsequent processing.

The term “prompt sentence” refers to a natural language or structured text instruction that is constructed based on analysis information and that specifies operation conditions and output conditions to control how a generative artificial intelligence model generates output.

The term “operation conditions” refers to constraints or parameters described in or associated with a prompt sentence that dictate how a generative artificial intelligence model should operate, including, for example, role, style, or behavior instructions.

The term “output conditions” refers to constraints or parameters described in or associated with a prompt sentence that dictate characteristics of the output text generated by a generative artificial intelligence model, including, for example, that the output must be a question, must omit direct answers, or must satisfy length or tone requirements.

The term “generative artificial intelligence model” refers to a computational model, typically realized as a trained neural network, that generates natural language text or other content in response to input data such as a prompt sentence.

The term “inquiry data” refers to data generated by the processor that includes at least a prompt sentence and optionally additional parameters, and that is configured to be input to a generative artificial intelligence model via a communication interface.

The term “communication path” refers to a logical or physical connection, such as a network link or communication channel, over which data is transmitted between the server and a generative artificial intelligence model or between the server and a terminal device.

The term “additional question” refers to a question generated by a generative artificial intelligence model based on a prompt sentence, which is intended to deepen the user's thinking about an original question rather than to provide a direct answer.

The term “post-processing” refers to one or more computational operations applied to text output from a generative artificial intelligence model, including validation, normalization, filtering, and transformation of the text before presentation to the user.

The term “interrogative sentence” refers to a sentence that is syntactically or semantically recognizable as posing a question, including sentences that are formed with interrogative words or question markers.

The term “format normalization” refers to modifying text to conform to predetermined formatting rules, including, for example, trimming unnecessary characters, standardizing punctuation, or correcting whitespace.

The term “content filtering” refers to evaluating and selectively modifying, rejecting, or flagging generated text based on predetermined criteria, such as removal of inappropriate, harmful, or irrelevant content.

The term “presentation question data” refers to data representing an additional question after post-processing, which is in a form suitable for transmission to and display on a terminal device.

The term “dialogue-type display area” refers to a user interface region on a terminal device that visually presents a sequence of messages, including user questions and system-generated questions, in a conversational or time-ordered layout.

The term “follow-up question” refers to an additional question that is generated in relation to a preceding question or context and that is intended to encourage further reflection or elaboration by the user.

The term “original question” refers to a question initially input by the user and provided to the server for analysis and for use as a basis for generating one or more additional questions.

The term “neural network based natural language generation processing” refers to a generation process in which a trained neural network model computes a sequence of output tokens representing natural language text, given an input such as a prompt sentence.

The term “predetermined condition” refers to a condition defined in advance by configuration data or program logic, used to evaluate whether a generated follow-up question is acceptable as an additional question, including conditions on length, relevance, or linguistic form.

The term “iterative dialogue” refers to a conversation process in which a sequence of interactions is repeated, including receiving user input, generating additional questions, and presenting them, thereby forming multiple turns of question-and-response exchanges.

In one embodiment, the invention is implemented as a dialogue system including at least a server, a terminal, and a user. The server includes a processor, a memory, a network interface, and a storage device. The terminal includes an input unit, a display unit, a local memory, and a communication interface. The user interacts with the terminal to input natural language questions and to receive additional questions generated by the server.

The server executes system software such as an operating system and middleware, and executes application software implementing natural language processing, prompt sentence construction, and interaction with a generative AI model. The server may run on general-purpose computing hardware, for example a rack-mounted computer or a virtual machine instance in a data center, equipped with a central processing unit and optionally a graphics processing unit. The server may further include an accelerator supporting tensor operations to efficiently execute deep neural network inference.

The server stores, in the memory and the storage device, a plurality of program modules, including but not limited to: a communication module, a text preprocessing module, a natural language analysis module, a prompt generation module, a model interaction module, a post-processing module, and a session management module. The server also stores trained parameter sets for a language-understanding model and a generative AI model, together with configuration data defining operation conditions, output conditions, and predetermined selection criteria.

The terminal executes a client application or web application that provides a dialogue-type user interface. The terminal may be a mobile computing device, such as a smartphone or tablet, or a stationary computing device, such as a desktop computer or notebook computer. The terminal provides a text input field and a conversation display area. The terminal converts keystrokes or touch input from the user into character data and transmits the data to the server through a network such as the Internet.

The user operates the terminal to input an original question in natural language. The user may, for example, input “Why does it rain?” or “I'm not sure what kind of job I want to do in the future.” The terminal acquires the input as a sequence of characters encoded in a character set and stores the sequence in local memory as text data. The terminal then transmits the text data to the server via the communication interface.

The server, upon receiving the text data, uses the text preprocessing module to normalize the question. The server converts the text into a unified encoding, removes control characters, normalizes whitespace, and may perform language identification by measuring character n-gram probabilities. The server then invokes the natural language analysis module, which may utilize a language-processing library such as a morphological analyzer, a syntactic parser, and a contextual encoder.

In one embodiment, the server uses a transformer-based encoder network as the language-understanding model. The server loads a model whose architecture includes an embedding layer, a plurality of self-attention layers, feed-forward layers, and layer normalization components. The server represents the question as a sequence of token identifiers, maps the sequence to dense vectors via the embedding layer, and passes the vectors through the stacked attention layers to produce contextual representations. The server uses these contextual representations to identify an intent label and extract elements of the question, such as content words, named entities, and interrogative type. The server may apply a classifier layer on top of the encoder output, using a softmax function to select an intent class, and may apply a tagging layer to identify tokens corresponding to key elements.

The server, using the analysis information, invokes the prompt generation module. The server constructs a prompt sentence that encodes explicit instructions for the generative AI model. The server defines operation conditions, such as a role of the model and a prohibition of direct answers, and defines output conditions, such as that the generated output must be a single question, must not exceed a certain length, and must remain semantically related to the original question. The server incorporates the original question and the analysis information into the prompt sentence.

For example, the server may generate a prompt sentence such as:

“The user asked the question: ‘Why does it rain?’. You are a tutor. Generate one follow-up question that encourages the user to think about the mechanism of rain. Do not provide any explanation or answer; output only a single question.”

As another example, the server may generate a prompt sentence such as:

“The user wrote: ‘I'm not sure what kind of job I want to do in the future.’ Generate one thought-provoking question that helps the user clarify their values and interests about their future career. Output only the question sentence.”

The server packages the prompt sentence together with model control parameters, such as maximum output length, sampling temperature, and top-k or top-p constraints, into inquiry data. The server then uses the model interaction module to transmit the inquiry data to the generative AI model. In one embodiment, the generative AI model is implemented as a large-scale transformer-based decoder network deployed on a separate computing node with GPU resources. In another embodiment, the generative AI model is hosted within the same server process, sharing memory with the application modules.

The server, or the node hosting the generative AI model, executes an auto-regressive generation algorithm. The server initializes the decoder with the tokenized prompt sentence, then iteratively computes, for each generation step, a probability distribution over the vocabulary by applying attention over past tokens and passing hidden states through feed-forward layers. The server samples or selects the next token according to the control parameters and appends the token to the sequence. The server repeats this procedure until a stop condition is met, such as encountering an end-of-sequence token or reaching a predetermined token limit. The resulting sequence of tokens is then decoded into a natural language string, which constitutes a candidate additional question.

The server returns the generated string to the application side, where the post-processing module operates on the string. The server verifies that the string constitutes an interrogative sentence by applying pattern recognition rules and statistical checks. The server checks for the presence of interrogative markers, analyzes the syntactic structure, and rejects outputs that appear to be declarative statements or contain direct answers to the original question. The server performs format normalization by trimming extraneous prefixes such as “Sure, here is a question:” and by standardizing punctuation. The server applies content filtering based on a set of rules or a trained moderation classifier, to remove or mask inappropriate content. The server stores the final text as presentation question data along with metadata, such as a conversation identifier and a link to the original question, in a persistent store.

The server then transmits the presentation question data to the terminal. The terminal receives the data and updates the conversation display area. The terminal displays the original question from the user and the additional question from the server in chronological order in a dialogue-type interface. The user reads the additional question on the display and may input a further response or another question. The terminal acquires the new input and transmits it to the server, and the server repeats analysis, prompt generation, model interaction, and post-processing, thereby forming an iterative dialogue.

In terms of data structures, the server may represent each conversation turn as a record including fields such as a turn identifier, a role label indicating user or system, a text field storing the question, and an analysis field storing extracted features. The server may maintain a conversation context list in memory, which the prompt generation module can consult to include limited prior context in the prompt sentence. By restricting context to a bounded number of turns and by encoding only selected features, the server improves memory usage and reduces communication load to the generative AI model.

The server improves computer technology in several ways. First, by separating the analysis of the user's question, the construction of the prompt sentence, and the post-processing of the generative output into distinct modules with explicit data structures, the server enables more precise control of the generative AI model. This increases the likelihood that the model outputs follow-up questions instead of direct answers, thereby reducing the number of failed responses and the need for repeated model calls. As a result, the server reduces network communication overhead and computational load, leading to improved throughput in multi-user environments.

Second, the server uses intent labels and extracted elements to parameterize the prompt sentence and model control parameters. For example, the server may set a lower sampling temperature and a shorter maximum length for fact-seeking questions, and may set a higher temperature and longer length for reflective questions about personal goals. This dynamic adjustment, driven by machine-readable analysis information, improves the relevance and diversity of generated questions. Because the server computes these adjustments algorithmically, using structured features rather than only passing raw text, the system achieves higher accuracy and lower variance in model outputs, which is a technical improvement over naive forwarding of user text to a generative AI model.

Third, the server's post-processing module enforces that the generative AI model's outputs conform to interrogative form and satisfy predetermined conditions before they are committed to the conversation record and sent to the terminal. This enforcement is implemented by concrete algorithms, such as classification based on parse trees, pattern matching, and thresholded confidence scores. By filtering or re-generating outputs that do not meet the conditions, the server reduces the number of unusable responses. This decreases wasted processing cycles and improves the stability of the user interface, which is a technical effect on the computing system itself.

Fourth, the server can be configured to batch multiple prompt sentences destined for the same generative AI model instance into a single batched request. The server then receives batched outputs, demultiplexes the outputs according to identifiers, and applies the post-processing module per output. This batching improves utilization of GPU resources and amortizes network latency, resulting in lower average response time per user and higher system throughput. Such resource-level optimization is specific to the computing environment and goes beyond mere automation of human dialogue.

In some embodiments, the server implements a customized training procedure for the generative AI model or a fine-tuning layer. The server may collect pairs of prompt sentences and generated additional questions that were successfully used in past dialogues, along with ratings of usefulness. The server may periodically update adapter parameters or a lightweight fine-tuning layer on top of the base model using gradient-based optimization. The server may define an objective function that penalizes outputs that contain direct answers or that fail to be interrogative, and rewards outputs that prolong user engagement. By training on this objective, the server adjusts the internal parameters so that the generative AI model more reliably produces deepening questions. This learning process involves computing loss values, back-propagating gradients through the network layers, and updating weights using an optimizer such as stochastic gradient descent or Adam. The result is an improvement in model behavior that is targeted specifically at the server-orchestrated task of question generation.

In other embodiments, the server combines rule-based processing with neural generation. The server may generate a first version of an additional question using the generative AI model and then apply a rule-based transformation to adjust the wording. For example, if the model outputs “It rains because water vapor condenses. Do you understand this?”, the server may remove the explanatory clause based on detection of causal connectives and retain only a question such as “What do you think causes water vapor in the air to condense?” The rule-based component operates according to explicit linguistic rules stored in a rule set, which is different from human judgment and can be executed at scale in the computing system.

The terminal may also participate in technical optimizations. The terminal may cache previously received additional questions and conversation context locally to support offline viewing, thereby reducing repeated requests to the server when the user scrolls through prior dialogue. The terminal may compress outgoing and incoming message payloads, using a compression algorithm, to reduce bandwidth consumption and latency. The terminal may adapt the display layout dynamically to the screen size and orientation, improving readability and reducing the need for excessive network access due to mistaken taps or scrolling.

The user, by interacting with the terminal, benefits from a consistent and responsive dialogue experience that is technically enabled by the server's specialized control over the generative AI model. The user's role is limited to providing natural language input and reading the additional questions; the complex analysis, prompt construction, and model interaction are handled by the coordinated operation of the server and the terminal.

Alternative embodiments may vary in the specific models and libraries used. The server may replace one transformer-based model with another having different numbers of layers or attention heads. The server may use different tokenization schemes, such as byte-pair encoding or unigram language model based segmentation. The server may employ different natural language processing toolkits for morphological and syntactic analysis. The overall architecture, however, remains characterized by the server's configuration to (i) analyze user questions to produce structured analysis information, (ii) generate prompt sentences encoding operation and output conditions for a generative AI model, and (iii) post-process generated text to reliably yield additional questions that deepen user thinking, all in a way that improves the behavior and efficiency of the computing system.

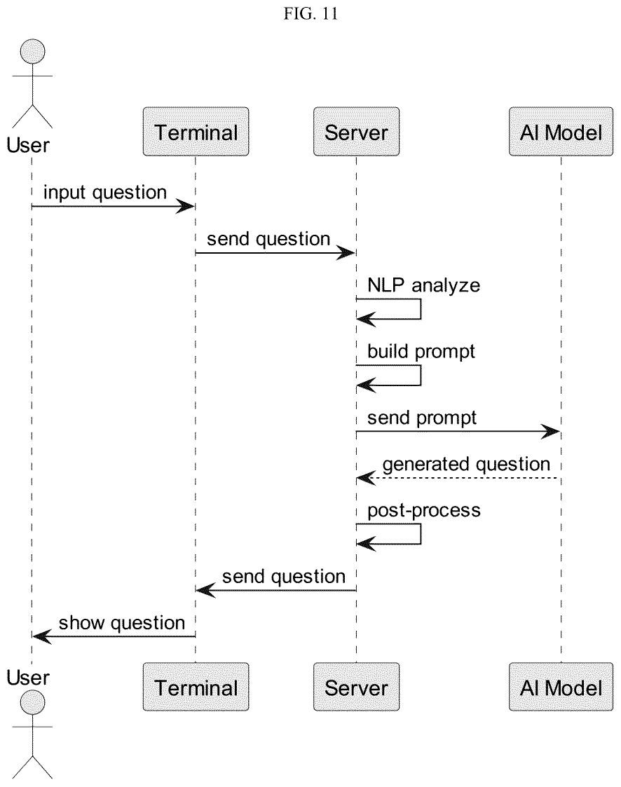

The following describes the processing flow using FIG. 11.

### Step 1

The user operates the terminal and inputs an original question in natural language into a text input field.

The input of this step is the user's keystrokes or touch operations, and the output is a text string representing the question.

The terminal converts the physical input events into a character sequence using its input subsystem, encodes the sequence in a character encoding, and stores the resulting text in a local buffer as digital character data.

### Step 2

The terminal prepares request data containing the text of the user's question and associated metadata such as a session identifier and a timestamp.

The input of this step is the text string stored in the local buffer, and the output is a structured data object, for example a JSON object including a field for the question.

The terminal serializes the structured data into a byte sequence suitable for network transmission and stores the serialized data in an outgoing message buffer.

### Step 3

The terminal transmits the outgoing message buffer to the server over a network using a communication protocol.

The input of this step is the serialized request data in the outgoing buffer, and the output is a network packet stream delivered to the server.

The terminal uses its communication interface and protocol stack to segment the data into packets, apply headers, and send the packets to the server's network address.

### Step 4

The server receives the network packet stream and reconstructs the original request data.

The input of this step is the incoming packet stream at the server's network interface, and the output is a parsed request object containing the user's question and metadata.

The server uses its communication module to reassemble packets, verify integrity, decode the byte sequence, and parse the structured data format to extract the question text.

### Step 5

The server normalizes the received question text to a standard internal representation.

The input of this step is the raw question text extracted from the request object, and the output is a normalized text string.

The server converts the text to a unified character encoding, removes or replaces control characters, compresses repeated whitespace, and applies optional language-detection algorithms to attach a language label.

### Step 6

The server performs basic linguistic segmentation and tagging on the normalized question text.

The input of this step is the normalized text string, and the output is a token sequence with associated linguistic attributes.

The server uses a natural language processing library to segment the text into tokens, assign part-of-speech tags, and record token positions, thereby producing a list or array of token data structures.

### Step 7

The server computes contextual representations and intent information from the token sequence.

The input of this step is the token sequence with linguistic attributes, and the output is analysis information including intent labels and extracted elements.

The server maps tokens to numerical vectors, feeds the vectors into a language-understanding model, obtains contextual embeddings, and applies classifier layers and tagging layers to derive an intent classification and to mark key elements and keywords.

### Step 8

The server constructs a structured analysis record from the intent information and extracted elements.

The input of this step is the raw model output consisting of embeddings and label scores, and the output is a compact analysis record.

The server selects labels whose scores exceed thresholds, converts indices to human-readable tags, aggregates them into a data structure that includes the original question, the intent label, and a list of important elements, and stores this structure in working memory.

### Step 9

The server generates a prompt sentence for a generative AI model based on the analysis record.

The input of this step is the analysis record stored in working memory, and the output is a prompt sentence expressed in natural language.

The server selects a template according to the intent label, fills the template placeholders with the original question and extracted elements, and concatenates operation conditions and output conditions into a single coherent instruction sentence.

### Step 10

The server determines control parameters for the generative AI model in association with the prompt sentence.

The input of this step is the prompt sentence and the analysis record, and the output is a set of generation parameters such as maximum length and sampling temperature.

The server maps the intent label and difficulty level to parameter values using predefined rules, creates a parameter object, and links it to the prompt sentence so that both can be passed together to the model.

### Step 11

The server forms inquiry data that encapsulates the prompt sentence and the control parameters.

The input of this step is the prompt sentence and the parameter object, and the output is a model-specific inquiry structure.

The server arranges the prompt and parameters into a request format required by the generative AI model, encodes the structure into a transmissible representation, and stores it in an outgoing model-request buffer.

### Step 12

The server transmits the inquiry data to the generative AI model through a communication path.

The input of this step is the outgoing model-request buffer, and the output is a model-input stream received by the generative AI model instance.

The server uses a network client or inter-process communication mechanism to send the encoded request to the model endpoint, ensuring that all fields are properly transmitted.

### Step 13

The generative AI model processes the prompt sentence and generates a token sequence representing an additional question.

The input of this step is the decoded prompt sentence and the associated control parameters, and the output is a sequence of output token identifiers.

The model converts the prompt into embeddings, applies its neural network layers iteratively to compute output probability distributions, selects or samples the next token at each step according to the control parameters, and repeats until a stop condition is met.

### Step 14

The server receives the generated token sequence from the generative AI model and decodes it into text.

The input of this step is the output token sequence returned by the model, and the output is a raw generated text string.

The server maps each token identifier to its corresponding character sequence, concatenates these characters in order, and forms a continuous sentence representing a candidate additional question.

### Step 15

The server verifies that the generated text conforms to interrogative form and system constraints.

The input of this step is the raw generated text string, and the output is either an approved text string or a decision to request regeneration.

The server applies syntactic analysis and pattern checking to detect question markers, calculates confidence scores that the sentence is interrogative and free of direct answers, compares these scores to thresholds, and either accepts the sentence or triggers another generation attempt with modified parameters.

### Step 16

The server normalizes the format of the approved generated text.

The input of this step is the approved text string from the verification step, and the output is a cleaned and standardized question string.

The server removes leading and trailing unnecessary phrases, corrects spacing and punctuation, ensures proper capitalization where applicable, and enforces length limits by truncating or adjusting nonessential parts of the sentence.

### Step 17

The server filters the content of the normalized question according to safety and relevance criteria.

The input of this step is the normalized question string, and the output is a filtered question string that satisfies policy rules.

The server scans the text for prohibited terms, evaluates it with a moderation classifier if configured, discards or replaces disallowed segments, and confirms that the remaining content is relevant to the original question context.

### Step 18

The server creates presentation question data for delivery to the terminal.

The input of this step is the filtered question string and the conversation metadata, and the output is a structured presentation record.

The server combines the question text with identifiers, timestamps, and association information linking it to the user's original question, and encodes this combination into a response object stored in an outgoing response buffer.

### Step 19

The server transmits the presentation question data to the terminal over the network.

The input of this step is the outgoing response buffer, and the output is a response packet stream destined for the terminal.

The server serializes the response object, encapsulates it in a network protocol, and sends the resulting packets through the network interface to the terminal's address.

### Step 20

The terminal receives the response packet stream and reconstructs the presentation question data.

The input of this step is the incoming packet stream at the terminal's communication interface, and the output is a parsed response object containing the additional question text and metadata.

The terminal reassembles packets, verifies integrity, decodes the serialized data, and parses the structure to extract the question text and associated identifiers.

### Step 21

The terminal updates the dialogue-type display area to present the additional question to the user.

The input of this step is the presentation question data contained in the parsed response object, and the output is an updated visual conversation state shown on the display.

The terminal inserts a new message element into the conversation view, sets its content to the additional question text, arranges the element in chronological order relative to the original question, and redraws the display so that the user can see the new question.

### Step 22

The user views the presented additional question and optionally provides a subsequent input.

The input of this step is the question displayed on the terminal's screen, and the output is a new user input sequence when the user chooses to respond.

The user reads the question, considers its content, and, if desired, enters another question or an answer through the input field, which the terminal again converts into text data for a new iteration of the processing flow.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional conversational systems that rely on natural language processing and question answering are primarily designed to return a direct answer to a user query as quickly as possible. Such systems generally treat each user utterance as an independent request, perform shallow intent recognition, and output a single response. As a result, these systems do not maintain or exploit a rich, structured representation of the evolving user state, and they do not systematically guide the user through a sequence of questions that gradually deepens the user's own thinking or clarifies latent preferences.

Further, in many existing architectures, the speech recognition, natural language understanding, and text generation components are loosely coupled and operate in a pipeline that is effectively stateless or minimally stateful. The output of a generative AI model is often used only once as a final answer, without being re-fed into an iterative control loop that updates an internal structured representation and re-configures the generative process. Consequently, the overall computational process is not optimized for iterative, user-specific deep exploration, but instead behaves as a sequence of isolated request-response transactions.

Moreover, conventional systems that employ generative AI models for dialogue typically construct prompts in an ad-hoc manner, for example by concatenating raw user utterances with fixed instructions. These systems do not systematically derive prompt sentences from machine-interpretable structured data produced by a natural language processing module. Thus, they fail to leverage a clear separation between (i) a symbolic or structured representation of user intent and context, and (ii) a downstream generative model that is controlled via a precisely formed prompt sentence. This lack of structure leads to unstable or inconsistent generation behavior, reduced controllability of the generative AI model, and inefficient use of computational resources.

In addition, user interfaces in existing dialog systems are often designed to display generated content passively on a generic display surface. Such systems do not tightly integrate the visual presentation layer with the iterative deep-question generation process in a way that explicitly treats the display device as a computational component for controlling user attention and guiding cognitive exploration over multiple turns. As a result, the system cannot reliably execute a multi-step, context-aware dialogue aimed at stepwise deepening of user thinking, particularly in constrained environments such as physical stores where the user's interaction time and attention are limited.

Accordingly, there is a need for an improved computer-implemented technique that (i) tightly integrates speech recognition, natural language processing, and generative AI models under unified control of a processor, (ii) maintains and updates structured data representing user intent and subject matter across multiple turns, (iii) programmatically constructs prompt sentences for a generative AI model from this structured data, and (iv) drives a visual display device in a way that supports continuous, stepwise deepening of the user's thinking. Such an improvement should enhance the functioning of the computer itself by introducing a new control architecture and data flow for iterative, context-driven generation, rather than merely automating a human mental process.

The specific processing by the specific processing unit 290 of the data processing device 12 in Application Example 1 is realized by the following means.

The present invention provides a server comprising a processor configured to receive audio information obtained from a user as input, convert the audio information into a character string representing a question from the user by using a speech recognition function, perform syntactic analysis and semantic analysis on the character string by using a natural language processing function to identify an intent and a subject of the question and to generate structured data including the intent and the subject, generate a prompt sentence for input to a generative AI model based on the structured data and the character string, cause the generative AI model to generate, in a natural language, an additional question for deepening thinking of the user by inputting the prompt sentence to the generative AI model, obtain the additional question output from the generative AI model, present the additional question to the user by using a visual display device having a display function, sequentially obtain responses of the user to the additional question by using the speech recognition function and the natural language processing function, update the structured data based on the responses, and regenerate and sequentially input updated prompt sentences to the generative AI model so as to continuously execute a dialogue for stepwise deepening of the thinking of the user. This enables an improved computer-implemented dialogue control architecture in which the server maintains and updates machine-interpretable structured data across multiple conversational turns, programmatically constructs and refines prompt sentences to control the generative AI model, and tightly coordinates recognition, understanding, generation, and visual presentation components, thereby enhancing the technical performance, stability, and controllability of iterative natural language interactions compared to conventional request-response systems.

The term “audio information” refers to machine-readable digital data representing sound waves produced by a user, including but not limited to sampled and encoded speech signals suitable for processing by a speech recognition function.

The term “character string” refers to a sequence of characters encoded in a computer-readable format that represents text, such as a question expressed in a natural language by a user.

The term “question from the user” refers to an utterance or input provided by a user that seeks information, clarification, or guidance, and that is expressed as text or as audio convertible into text.

The term “speech recognition function” refers to a hardware-implemented or software-implemented function that converts audio information including human speech into corresponding character information representing text.

The term “natural language processing function” refers to a hardware-implemented or software-implemented function that analyzes text expressed in a human language, including operations such as tokenization, syntactic analysis, semantic analysis, and intent recognition.

The term “syntactic analysis” refers to processing that determines structural relationships among words in a character string, such as part-of-speech assignment and dependency or constituency parsing, to identify a grammatical structure of the character string.

The term “semantic analysis” refers to processing that interprets the meaning of a character string, including identification of an intent, subject, and relevant entities or attributes expressed in the character string.

The term “intent of the question” refers to an abstract representation of a purpose or objective underlying a question from the user, such as requesting usage instructions, comparing items, or asking for recommendations.

The term “subject of the question” refers to a main topic or target object that the question from the user concerns, such as a particular item, feature, situation, or concept.

The term “structured data” refers to data represented in a machine-interpretable format, such as a record, object, or key-value set, that explicitly includes fields corresponding to at least an identified intent and a subject of a question from the user.

The term “generative AI model” refers to a machine learning model having a generative language processing function, the model being configured to receive a prompt sentence as input and to output generated natural language text based on statistical or learned representations.

The term “generative language processing function” refers to functionality of a model or program that produces new natural language text as output in response to input text, according to learned patterns or parameters.

The term “prompt sentence” refers to a text input provided to a generative AI model, the text input including at least part of a question from the user and structured information such as an intent or subject, and being used to condition or control an output of the generative AI model.

The term “additional question” refers to a question generated by the generative AI model based on a prompt sentence, the question being intended to further explore, clarify, or deepen the thinking of the user regarding an earlier question or context.

The term “deepening thinking of the user” refers to causing the user to reflect more thoroughly on needs, preferences, assumptions, or objectives by presenting one or more additional questions that explore the user's context in a stepwise or iterative manner.

The term “visual display device” refers to an electronic device having a display function for presenting visual information to a user, including but not limited to a portable information terminal or a head-mounted display device.

The term “portable information terminal” refers to a handheld or body-carried electronic apparatus having a display and communication capabilities, such as a mobile terminal, a tablet terminal, or a similar portable computing device.

The term “head-mounted display device” refers to a wearable electronic apparatus configured to be worn on a head of a user and to display visual information within a field of view of the user, including augmented reality and virtual reality display devices.

The term “overlay-displaying” refers to presenting text or other visual information superimposed on, or in conjunction with, a base image or background on a display screen so that the presented information appears as an overlaid element within the user's field of view.

The term “response of the user” refers to follow-up input provided by the user after presentation of an additional question, the input being expressed as audio information or text that can be processed by the speech recognition function and the natural language processing function.

The term “dialogue for stepwise deepening” refers to an interaction process in which multiple conversational turns are executed in sequence, each turn including at least one additional question generated based on updated structured data, thereby progressively refining and deepening the user's expressed thinking.

In one embodiment, a server implements the claimed system as a network-connected computing device including at least one central processing unit (CPU), an optional graphics processing unit (GPU), a volatile memory, a non-volatile memory, and a network interface. The server runs an operating system such as a general-purpose server operating system and executes middleware and application software modules implementing a speech recognition function, a natural language processing function, a generative AI model interface, a dialogue state manager, and a display control interface. A terminal, which may be a portable information terminal such as a smartphone or tablet, or a head-mounted display device such as smart glasses, communicates with the server via a wired or wireless communication network. A user interacts with the system by speaking into a microphone of the terminal and by viewing text presented on a display of the terminal or the head-mounted display device.

The server uses a speech recognition engine that can be realized, for example, by a cloud-based speech-to-text service implementing deep neural acoustic models and language models. In one configuration, the speech recognition engine is compatible with an interface similar to a publicly available speech-to-text API. The terminal captures audio information representing the user's speech via a built-in microphone and transfers digitized audio samples (for example, 16-bit PCM at 16 kHz) to the server over an encrypted network connection. The server stores the audio in a buffer structure in main memory and invokes the speech recognition function with parameters specifying the sampling rate, encoding format, and language code.

The speech recognition function converts the audio information into a character string by applying feature extraction and pattern classification. The feature extraction may include computation of mel-frequency cepstral coefficients (MFCCs) or log-mel filter bank features from short-time frames of the audio signal. The classification may be performed by a deep neural network-based acoustic model, such as a recurrent neural network or a transformer-based network, trained on large-scale speech corpora. The acoustic model outputs probability distributions over phonetic units or characters for each time frame, and a decoder combines these distributions with a statistical language model to determine the most likely character sequence. The server receives a recognition result including at least one candidate transcript and scores, and the server selects the candidate with the highest confidence as the character string representing the question from the user.

The server then applies a natural language processing function to the character string. The natural language processing function may be implemented by software similar to a general-purpose NLP library such as spaCy, running on the server. The server loads a pre-trained language model for the relevant language (for example, a Japanese core news model) into memory. The model internally uses a neural network architecture, such as a convolutional or transformer-based encoder, to encode token sequences into contextual representations. The NLP pipeline performs tokenization, part-of-speech tagging, syntactic dependency parsing, and named entity recognition. The server obtains for each token a part-of-speech label, a dependency relation, and an entity type.

The server constructs structured data from the NLP output. The structured data is represented in a machine-interpretable format such as a key-value record stored in memory or in a fast in-memory data store. The server defines fields including at least an intent field, a subject field, and optional fields such as attribute fields and context fields. The server applies rule-based and model-based intent classification. For example, the server uses a feed-forward classifier neural network trained on labeled question data to map a sentence embedding to one of several intent categories, such as “ask_usage,” “compare_items,” or “ask_recommendation.” The sentence embedding may be computed by averaging token vectors output by the NLP encoder or by using a dedicated sentence embedding model. The subject is extracted by locating the syntactic head of the direct object or named entity closely associated with the main verb of the question. The server writes these extracted values into the structured data, thus generating a record that includes, for instance, “intent=ask_usage” and “subject=product_X.”

The server maintains a dialogue state for each user session. The dialogue state is kept in a session store such as a key-indexed record in memory or in a database. The dialogue state includes the latest structured data, a history of previous questions and additional questions, and metadata such as timestamps and confidence scores. The server updates the dialogue state each time a new utterance is processed. This persistent structured representation constitutes a machine-readable context that is reused to control subsequent processing. By relying on this structured context, the server reduces repeated recomputation and can filter out noise or recognition errors by applying consistency checks across turns.

The server generates a prompt sentence for a generative AI model. The generative AI model may be a large-scale neural network-based language model that follows a transformer architecture, trained on extensive natural language corpora. Such a model receives a text input sequence and outputs a probability distribution over next tokens at each generation step. The server does not expose the user directly to the raw model but instead programmatically constructs a prompt sentence to control the model's behavior. For this purpose, the server defines templated prompt structures stored as data in memory.

The server assembles the prompt sentence by concatenating template text segments with the character string representing the user's question and fields from the structured data. For example, the server can form a prompt sentence such as:

“User question: ‘How do I use this product?’ Intent: ask_usage. Please generate one follow-up question that deepens the user's thinking about expected benefits, usage scenarios, or preferences.”

In another example, the server can embed additional contextual information derived from previous turns, such as:

“User question: ‘How do I use this product?’ Additional information: The user wants something that helps them relax after work. Based on this, generate one follow-up question that further deepens the user's thinking about when, where, and how they plan to use the product.”

By explicitly encoding intent, subject, and additional context into the prompt sentence, the server constrains and focuses the generative AI model's output, thereby improving coherence and relevance and reducing the computational overhead associated with generating and discarding unsuitable responses.

The generative AI model interface on the server prepares an input sequence for the model by converting the prompt sentence into token identifiers through a tokenizer. The generative AI model internally uses multiple layers of self-attention, feed-forward networks, and layer normalization to compute contextualized vector representations for each token. The model calculates the probability distribution of the next token using a softmax function over the output layer and samples or selects tokens according to specified decoding parameters, such as temperature and top-k or nucleus sampling thresholds. The server sets these parameters to favor concise, single-question outputs with high semantic relevance, reducing the need for repeated generation attempts and thus reducing computation time.

The server receives the output sequence from the generative AI model and converts it back into a character string. The server applies post-processing to ensure that the string is a well-formed question. Post-processing can include trimming leading and trailing whitespace, removing extraneous labels such as “Q:” prefixes, and ensuring that the sentence ends with a question mark. The server also applies a content filter to detect and remove inappropriate or off-topic content using pattern matching or a lightweight classifier. If the output fails certain quality criteria, the server can regenerate by modifying the prompt sentence to be more constrained, which reduces the number of iterations needed to obtain an acceptable output.

The server uses a display control interface to send the additional question to the terminal. The terminal runs a client program that receives a message containing at least the additional question and, optionally, other text such as a direct answer. The terminal renders the additional question on its display. When the terminal is a portable information terminal, the additional question is presented in a user interface element such as a text bubble within a dialogue application screen. When the terminal is a head-mounted display device, the additional question is overlay-displayed in the user's field of view using display drivers and an augmented reality rendering pipeline. In this case, the terminal maps the text to screen coordinates and blends it with the background image. This overlay display enables the user to receive guidance without diverting attention from the physical environment.

The user reads the additional question and may respond verbally by providing a new utterance. The terminal captures the new audio information and transmits it to the server. The server again executes the speech recognition function and the natural language processing function, generating an updated character string and structured data. The updated structured data may include new attributes derived from the response, such as “desired_effect=relaxation” or “preferred_time=after_work.” The server merges these attributes into the existing dialogue state. Because the server maintains a cumulative record of extracted attributes and intent refinements, it avoids re-asking unnecessary questions and focuses subsequent additional questions on unexplored aspects, which reduces network traffic and computational load.

In another embodiment, the server also uses the dialogue state to query a knowledge base or a recommendation engine. The server can transform the structured data fields into search constraints, such as product category, desired effect, and usage context, and submit these constraints to an indexed storage system such as a search engine. The search engine returns a ranked list of candidate items. The server then constructs a new prompt sentence that includes concise descriptions of the candidate items and instructs the generative AI model to formulate an explanation, for example:

“Context: The user wants a product that helps them relax after work at home. Candidate products: Product A (short description), Product B (short description), Product C (short description). Please explain in simple terms why Product B best fits the user's needs and what follow-up question should be asked to confirm the user's preferences.”

This approach uses the generative AI model not simply as a black box responder but as a controlled language generator driven by structured, machine-interpretable data. The tight integration between structured data generation, prompt sentence construction, and generative output results in improved technical behavior such as more accurate focus on user needs, fewer irrelevant generations, and reduced latency.

From a technical perspective, the system improves computer technology in several ways. First, by maintaining structured dialogue state and reusing it to construct prompt sentences, the server avoids recomputing context from scratch for every user turn, which reduces the number of tokens that must be processed by the generative AI model and decreases processing time and resource consumption. Second, by combining deterministic rule-based extraction and learned intent classification, the natural language processing function filters and compresses the raw text into compact structured data, which improves the efficiency of downstream processing and reduces the size of data transmitted between modules. Third, by enforcing specific quality constraints and regeneration strategies on the generative AI output, the server reduces the rate of unusable responses, minimizing additional model calls and thereby improving throughput and response time.

The generative AI model used in the server is trained offline before deployment. Training data consist of pairs of prompt-like inputs and desirable question outputs. The model is trained with a supervised learning objective minimizing a cross-entropy loss between predicted and target token sequences. During training, the server (or a training system) performs backpropagation of the loss through the transformer layers and updates model parameters using an optimization algorithm such as Adam. The training process may use data augmentation methods, for example paraphrasing training questions and using multiple variants of deepening questions, to improve generalization. The resulting model parameters are then fixed for inference. At runtime, only forward passes of the model are executed, and no training data or labels are required. The separation between training and inference, together with the structured prompt construction, enables predictable and stable inference behavior.

In some embodiments, the server employs multiple generative AI models or multiple configurations of a model. For example, one configuration may be optimized for generating short, single-sentence additional questions, while another configuration may be optimized for generating multi-sentence explanations. The server selects which configuration to use based on structured data fields, such as the complexity of the user's intent or the stage of the dialogue. This selection logic is implemented as a deterministic algorithm executed on the server, which reads the dialogue state and sets appropriate model parameters and decoding strategies. Such explicit control over model usage allows the system to reduce unnecessary computation and tailor the generation process to different technical requirements.

In another embodiment, the terminal implements part of the processing locally. The terminal can perform initial speech recognition using a compact on-device model and then send both the recognized text and the original audio to the server. The server then uses the text as a first hypothesis and can invoke server-side speech recognition only if the confidence of the on-device model is below a threshold. This hybrid arrangement reduces communication load and server-side computation when local recognition is sufficiently accurate. Similarly, the terminal may cache recently received additional questions and associated dialogue state so that the server can refer to cached data rather than recomputing or retransmitting repeated content.

The system distinguishes itself from simple automation of human tasks by introducing machine-specific data structures and processing flows that have no direct counterpart in human reasoning. For example, the structured data representation of intent and subject, the explicit tracking of confidence scores, and the algorithmic construction and regeneration of prompt sentences are specific to the computing environment. The system uses these constructs to optimize resource usage, improve recognition and generation accuracy, and provide deterministic control over a probabilistic generative process. The technical improvements manifest in faster response times, reduced model-inference calls, improved alignment between user needs and generated questions, and more efficient network utilization.

Although the embodiments described above use certain example software libraries and model architectures, the server can implement equivalent functions using different software components or hardware accelerators. The speech recognition function may be realized by any engine capable of mapping audio signals to text, the natural language processing function may be implemented by different parsing and classification frameworks, and the generative AI model may be any large-scale language model based on neural network architectures, including but not limited to transformer-based models. The terminal can be any device having input and output capabilities, and the visual display device can be a portable display, a head-mounted display device, or any other device capable of overlay-displaying text to a user. Thus, multiple variations and modifications can be made without departing from the scope defined by the claims.

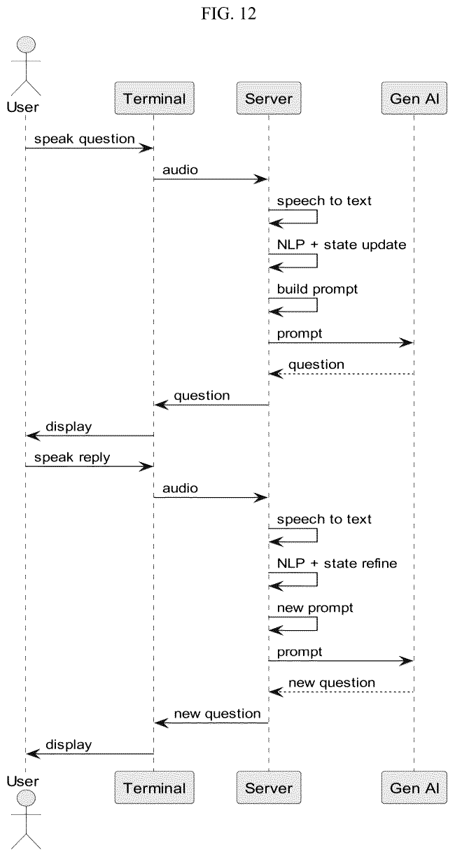

The following describes the processing flow using FIG. 12.

### Step 1

The user provides an initial utterance.

The user speaks a question in natural language, such as “How do I use this product?”, toward a microphone of the terminal. The input of this step is an analog speech signal produced by the user. The output of this step is an analog audio waveform captured by the terminal's microphone hardware.

### Step 2

The terminal digitizes and transmits the audio.

The terminal converts the analog audio waveform into digital audio samples (for example, 16-bit PCM at 16 kHz, mono) using an analog-to-digital converter and an audio driver of the operating system. The terminal packages a sequence of audio frames into a request message and sends the message to the server over a network connection using a communication protocol such as HTTPS. The input of this step is the analog audio waveform from Step 1. The output of this step is a digital audio data stream transmitted to the server.

### Step 3

The server performs speech recognition.

The server receives the digital audio data stream from the terminal and stores it in a buffer in main memory. The server calls a speech recognition function, implemented for example by a deep neural network-based speech-to-text engine, with the buffered audio as input. The speech recognition function extracts acoustic features (such as mel-frequency cepstral coefficients) from short, overlapping time windows of the audio, applies an acoustic model (such as a recurrent or transformer-based neural network) to estimate probabilities of phonetic units or characters, and uses a decoder with a language model to search for the most probable character sequence. The input of this step is the buffered digital audio stream. The output of this step is at least one recognized text candidate, and the server selects the highest-confidence candidate as the character string representing the user's question.

### Step 4

The server performs natural language preprocessing.

The server normalizes the recognized character string by converting character encodings, unifying punctuation, and removing non-speech artifacts, using text processing functions. The server then passes the normalized string into a natural language processing pipeline, which tokenizes the text into word units, assigns part-of-speech tags, and performs sentence segmentation. The input of this step is the recognized character string from Step 3. The output of this step is a tokenized and annotated sequence of words prepared for deeper analysis.

### Step 5

The server performs syntactic and semantic analysis.

The server applies a syntactic parser and a semantic analyzer implemented in the natural language processing function to the tokenized sequence. The parser computes a dependency tree or similar structure that encodes grammatical relations between tokens, and the semantic analyzer identifies named entities, key phrases, and semantic roles. The server then computes a sentence representation (for example, by averaging contextual token embeddings) and inputs this representation into an intent classification module (such as a feed-forward neural network) to infer a discrete intent label like “ask_usage” or “compare_items.” The input of this step is the tokenized and annotated word sequence from Step 4. The output of this step is a structured analysis result including an intent label, a subject candidate, and associated entities.

### Step 6

The server constructs structured dialogue data.

The server converts the analysis result into structured data stored as a record or object in memory. The server assigns values to predefined fields, such as “intent,” “subject,” “entities,” and “confidence,” based on the syntactic head of the direct object, the identified named entities, and the classifier's output. If a dialogue state record for the current session already exists, the server merges new fields or updates existing fields while preserving relevant historical data. The input of this step is the analysis result from Step 5. The output of this step is a structured dialogue state object representing the user's current question and context.

### Step 7

The server determines the need for a deepening question.

The server applies rule-based logic or a lightweight decision model to the structured dialogue data to decide whether an additional, deepening question should be generated. For example, the server checks whether the intent belongs to a predefined set (such as “ask_usage” or “ask_recommendation”), whether key attributes are missing, or whether confidence scores are below thresholds. The server sets a control flag in the dialogue state, such as “need_deepening_question=true,” when criteria are met. The input of this step is the structured dialogue state from Step 6. The output of this step is an updated dialogue state that includes a decision flag guiding subsequent generation behavior.

### Step 8

The server generates a prompt sentence for the generative AI model.

The server retrieves one or more prompt templates from a prompt template store. The server fills template slots with values taken from the dialogue state, including the original question text, the intent label, the subject, and any additional contextual attributes. The server concatenates these elements into a single prompt sentence. For example, the server may assemble the following prompt sentence:

“User question: ‘How do I use this product?’ Intent: ask_usage. Please generate one follow-up question that deepens the user's thinking about expected benefits, usage scenarios, or preferences.”

The input of this step is the structured dialogue state and the recognized question text. The output of this step is a prompt sentence formatted as a single text string ready to be consumed by the generative AI model.

### Step 9

The server invokes the generative AI model with the prompt sentence.

The server tokenizes the prompt sentence into a sequence of token identifiers using a tokenizer compatible with the generative AI model and packages the token sequence into a model input object. The server sends this object to the generative AI model, which runs on a computing platform implementing a transformer-based neural network. Inside the model, multiple self-attention layers compute contextual embeddings for each token, and a final layer outputs a probability distribution over the vocabulary for each generation step. The server configures decoding parameters such as temperature and maximum token length and requests a generated completion. The input of this step is the prompt sentence from Step 8. The output of this step is a generated token sequence representing a candidate additional question.

### Step 10

The server post-processes the model output to obtain an additional question.

The server converts the generated token sequence back into a character string using the tokenizer's decoding function. The server removes any leading or trailing whitespace, strips auxiliary markers such as “Q:” prefixes, and verifies that the string is syntactically a question by checking for an interrogative structure or a trailing question mark. The server may apply a content filter to detect prohibited or irrelevant content, using pattern matching or a classifier. If the string fails quality checks, the server modifies the prompt sentence (for example, by adding stricter constraints) and repeats Steps 9 and 10. The input of this step is the generated token sequence from Step 9. The output of this step is a cleaned additional question string suitable for presentation to the user.

### Step 11

The server updates the dialogue state with the additional question.

The server records the additional question in the dialogue state by appending it to a history list and by associating it with identifiers such as a turn index and timestamp. The server may also record metadata about the generation, including model configuration and decoding parameters used. The input of this step is the additional question from Step 10 and the existing dialogue state. The output of this step is an updated dialogue state that now includes the generated additional question as part of the conversation history.

### Step 12

The server sends the additional question to the terminal.

The server creates a response payload containing at least the additional question and the necessary identifiers for the current session. The server serializes this payload into a message format such as JSON and transmits it to the terminal via a network protocol, for example HTTPS. The input of this step is the additional question and the dialogue state from Step 11. The output of this step is a network message carrying the additional question to the terminal.

### Step 13

The terminal renders the additional question on the visual display device.

The terminal receives the response payload from the server and parses it to extract the additional question string. When the terminal is a portable information terminal, the terminal's user interface module creates a text view or similar widget and sets its content to the additional question, then instructs the display driver to draw the widget on the screen. When the terminal is a head-mounted display device, the terminal overlays the additional question at designated coordinates in the user's field of view using an augmented reality rendering engine. The input of this step is the response payload from Step 12. The output of this step is a rendered visual representation of the additional question displayed to the user.

### Step 14

The user provides a response to the additional question.

The user reads the additional question on the visual display device and considers its content. The user then vocalizes a response, such as “I want something that helps me relax after work,” which expresses new information about preferences or context. The input of this step is the displayed additional question and the user's cognitive reaction. The output of this step is a new analog speech signal captured by the terminal's microphone.

### Step 15

The terminal and server process the user's response and refine the dialogue state. The terminal digitizes the user's new speech, as in Step 2, and sends the digital audio to the server. The server repeats Steps 3 to 6 on this new audio: the server performs speech recognition to obtain a response text, applies natural language processing to extract entities and attributes such as “desired_effect=relaxation” and “time=after_work,” and updates the structured dialogue state with these additional attributes. The input of this step is the analog speech of the user's response from Step 14. The output of this step is a refined dialogue state incorporating new, machine-interpretable information from the user's response.

### Step 16

The server generates a subsequent prompt sentence based on the refined dialogue state.

The server uses the updated dialogue state from Step 15 to create a new prompt sentence that references both the original question and the newly extracted attributes. The server selects an appropriate template and fills in slots with fields such as “desired effect” and “time.” For example, the server may generate the following prompt sentence:

“User question: ‘How do I use this product?’ Additional information: The user wants something that helps them relax after work. Based on this, generate one follow-up question that further deepens the user's thinking about when, where, and how they plan to use the product.”

The input of this step is the refined dialogue state and previously stored question text. The output of this step is an updated prompt sentence, which the server then uses as input to the generative AI model in a subsequent execution of Steps 9 and 10, thereby continuing the iterative dialogue.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional dialog systems that utilize natural language processing and generative artificial intelligence models typically focus on returning a direct answer to a user's question as quickly as possible. In many implementations, server-side processing is optimized only for single-turn question answering, in which a user query is mapped to a single response, and the processing pipeline does not explicitly model user intention, user understanding level, or the progression of the user's thinking across multiple turns. As a result, such systems often fail to support deeper cognitive engagement, iterative reasoning, or stepwise learning by the user.

From a computer-technology perspective, the conventional architectures and algorithms for natural language dialog processing have several technical limitations. First, server-side modules generally treat each user input as an isolated text string and do not perform structured extraction of topics or concepts together with an estimation of the user's understanding level. This leads to inefficient use of computational resources of the generative artificial intelligence model, because the model is invoked without a context-sensitive prompt design tailored to the user's thinking state. Second, the prompt sentences supplied to the generative artificial intelligence model are often static or only lightly parameterized, and are not systematically reconstructed based on a detailed dialog history stored and managed by the server. Consequently, the generative artificial intelligence model tends to produce generic responses that do not optimally guide the user's reasoning process, and additional computational steps are required on the client side or through repeated calls to the model to approximate a multi-step explanation.

Furthermore, in many existing systems, storage and use of dialog history are limited to simple logging. The stored data is not actively leveraged by the processing unit to dynamically control response content or response style of the generative artificial intelligence model in accordance with a depth of the user's thinking or the user's understanding level. This leads to redundant, repetitive generation operations and increased network traffic, because the server must frequently reconstruct context from scratch for each call to the generative artificial intelligence model. In addition, the prompt sentences do not systematically encode machine-readable constraints, output formats, or dialog policies that could enhance the determinism, controllability, and efficiency of the model's outputs.

Therefore, there is a need for an improved computer-implemented dialog system and associated server-side processing that: (i) performs structured analysis of user input to extract topics or concepts and to identify user intention or understanding level; (ii) constructs and reconstructs prompt sentences for a generative artificial intelligence model in a way that is conditioned on dialog history and computed linguistic features; and (iii) dynamically controls the behavior of the generative artificial intelligence model so as to generate both follow-up questions that deepen the user's thinking and explanatory answers that promote the user's understanding, while improving the efficiency, consistency, and technical quality of the overall dialog processing pipeline.

The specific processing by the specific processing unit 290 of the data processing device 12 in Example 2 is realized by the following means.

The present invention provides a server comprising a processor configured to receive, from a terminal, natural language information provided by a user, to perform syntactic analysis or semantic analysis on the received natural language information by using a natural language processing technique so as to extract at least one topic or concept included in the natural language information and to identify an intention or a level of understanding of the user, to construct a first prompt sentence including operation conditions and a response format for a generative artificial intelligence model based on the identified intention or level of understanding and the extracted topic or concept, to input the first prompt sentence to the generative artificial intelligence model so as to cause the generative artificial intelligence model to generate, in natural language, an additional question for deepening the user's thinking, to present the generated additional question to the user via the terminal and to receive, from the terminal, an answer of the user to the additional question, to reconstruct, based on a dialog history including at least a part of the received natural language information, the additional question, and the user's answer, a second prompt sentence for causing the generative artificial intelligence model to generate an explanatory answer that promotes understanding by the user, to input the second prompt sentence to the generative artificial intelligence model so as to cause the generative artificial intelligence model to generate, in natural language, the explanatory answer, and to present the generated explanatory answer to the user via the terminal, and further configured to store, in a storage device, the natural language information provided by the user, the generated additional question, the user's answer, and the generated explanatory answer in association with identification information and time information, and to update at least one of the first prompt sentence and the second prompt sentence based on the stored dialog history so as to dynamically control response content or a response style of the generative artificial intelligence model in accordance with a depth of the user's thinking or the level of understanding of the user, and to change at least one constraint condition, output format, or dialog policy included in a prompt sentence to be input to the generative artificial intelligence model in accordance with at least one of a topic, a keyword, a text length, and a writing style calculated as an analysis result by the natural language processing technique, thereby causing the generative artificial intelligence model to generate both the additional question for deepening the user's thinking and the explanatory answer for promoting the user's understanding. This enables the server-side dialog processing pipeline to more efficiently and accurately control the behavior of the generative artificial intelligence model based on structured linguistic analysis and dialog history, to reduce redundant computation and network overhead, and to provide context-aware follow-up questions and explanatory answers that technically improve the quality, consistency, and adaptability of computer-implemented interactive learning and reasoning support.

The term “processor” refers to one or more hardware-based processing units, such as a central processing unit or a graphics processing unit, and any associated control circuitry, configured to execute instructions that implement the functions described in the present disclosure.

The term “terminal” refers to an electronic device including at least an input unit, an output unit, and a communication unit, such as a portable information processing device or a stationary information processing device, that is configured to transmit user input to a server and present information received from the server to the user.

The term “user” refers to a human operator who interacts with the system by providing natural language information through the terminal and by perceiving questions and answers presented by the system.

The term “natural language information” refers to information expressed in a human language, such as text data representing a sentence, phrase, or utterance, that can be processed by a natural language processing technique.

The term “natural language processing technique” refers to a computational method or algorithm that analyzes natural language information, including at least one of tokenization, syntactic analysis, semantic analysis, part-of-speech tagging, named entity recognition, or topic extraction.

The term “syntactic analysis” refers to processing that determines a structural relationship among words or phrases in natural language information, such as parsing a sentence into a grammatical structure.

The term “semantic analysis” refers to processing that estimates a meaning or role of words, phrases, or sentences in natural language information, including identification of concepts, topics, or relationships between entities.

The term “topic” refers to a subject matter or theme inferred from natural language information, such as a field, object, or phenomenon that is discussed in a user's statement.

The term “concept” refers to an abstract or concrete idea, notion, or entity that can be extracted from natural language information as a unit of meaning.

The term “intention” refers to an inferred purpose, goal, or objective of the user as estimated from the content and context of the natural language information.

The term “level of understanding” refers to an estimated degree of knowledge, comprehension, or familiarity of the user with respect to a topic or concept, as inferred from the natural language information and dialog history.

The term “generative artificial intelligence model” refers to a computational model, such as a machine-learned language model, configured to generate natural language text outputs in response to input data including a prompt sentence.

The term “prompt sentence” refers to a sequence of symbols including at least one natural language instruction, condition, or example, supplied to a generative artificial intelligence model for controlling a content, style, or structure of an output generated by the generative artificial intelligence model.

The term “operation conditions” refers to one or more parameters, constraints, or instructions included in a prompt sentence that specify how the generative artificial intelligence model should behave, such as a requested role, tone, temperature, length, or focus of the output.

The term “response format” refers to a specification included in a prompt sentence that defines a structural or stylistic requirement for an output of the generative artificial intelligence model, such as a question form, explanation form, list form, or length limitation.

The term “additional question” refers to a question generated by the generative artificial intelligence model, based on a prompt sentence, that is intended to deepen the user's thinking or to elicit further information from the user.

The term “explanatory answer” refers to a response generated by the generative artificial intelligence model, based on a prompt sentence, that provides an explanation, clarification, or supplementary information for promoting the user's understanding of a topic or concept.

The term “dialog history” refers to stored information representing at least part of a sequence of interactions between the user and the system, including the user's natural language information, additional questions generated by the system, answers provided by the user, and explanatory answers generated by the system, optionally associated with identification information and time information.

The term “identification information” refers to data that distinguishes one dialog, user, or interaction from another, such as a conversation identifier, user identifier, or session identifier.

The term “time information” refers to temporal data associated with an interaction event, such as a timestamp indicating when natural language information, an additional question, a user's answer, or an explanatory answer was generated, transmitted, or stored.

The term “storage device” refers to one or more physical information storage media, such as a magnetic storage medium, semiconductor storage medium, or optical storage medium, configured to store dialog history or related data in association with identification information and time information.

The term “response content” refers to a semantic substance or informational meaning of an output generated by the generative artificial intelligence model in response to a prompt sentence.

The term “response style” refers to a manner or tone in which the generative artificial intelligence model expresses a response, including at least one of complexity level, politeness level, formality, or didactic orientation.

The term “constraint condition” refers to a rule or limitation included in a prompt sentence that restricts or shapes an output of the generative artificial intelligence model, such as a prohibition of certain topics, a requirement for brevity, or a requirement for specific output structure.

The term “output format” refers to a structural specification of an output of the generative artificial intelligence model, such as a sentence, paragraph, bulleted list, or formatted data string.

The term “dialog policy” refers to a strategy or rule set that governs how the system or the generative artificial intelligence model progresses a dialog, including when to ask an additional question, when to provide an explanatory answer, and how to adapt to the user's level of understanding.

The term “text length” refers to a quantitative measure of a size of natural language information, such as a number of characters, tokens, or words contained in a user's input or in an output of the generative artificial intelligence model.

The term “writing style” refers to a characteristic pattern of expression in natural language information, including at least one of formality, technicality, narrative style, or use of domain-specific terminology.

In one embodiment, a server cooperates with one or more terminals operated by users to implement a dialog system that deepens a user's thinking and promotes understanding by controlling a generative AI model through structured prompt sentences and dialog history. The server is realized by a general-purpose computing device including at least one processor, a memory, a storage device, a network interface, and a system bus. For example, the server may be implemented on a rack-mounted computing system running a server operating system on a multi-core central processing unit and optionally one or more graphics processing units. The memory may include volatile memory, and the storage device may include non-volatile memory such as a magnetic disk drive or a solid-state drive. The network interface may be configured to communicate over wired or wireless networks using a standard communication protocol stack.

The terminal is realized by an information processing device such as a smartphone, tablet, notebook, desktop, or dedicated appliance. The terminal includes at least a display, an input interface, a memory, and a communication interface. The terminal executes a client program, which may be a web application running on a web browser or a native application. The terminal provides a graphical user interface including a text input field and a message display area to allow the user to input natural language information and to view questions and answers returned from the server.

The server stores in the storage device a plurality of software modules executed by the processor. These modules include at least: a communication module, a natural language processing module, a prompt construction module, a generative AI model interface module, a dialog history management module, and a presentation control module. The communication module manages the exchange of messages with terminals via the network interface. The natural language processing module processes natural language information received from the terminal. The prompt construction module generates and updates prompt sentences tailored to the analysis results. The generative AI model interface module manages calls to a generative AI model, which may be executed on the same server, on a separate computational node, or on an external service. The dialog history management module stores and retrieves dialog data. The presentation control module prepares content to be transmitted back to the terminal for display.

The server uses the natural language processing module to perform syntactic and semantic analysis on natural language information provided by the user. In one implementation, the server applies tokenization to segment a received text string into tokens, applies part-of-speech tagging, and executes dependency parsing using a statistical or neural parsing algorithm. The server identifies candidate topic tokens by evaluating frequency statistics, syntactic roles (such as subjects, objects, and head nouns), and semantic categories obtained from a domain-agnostic semantic tagger. The server further computes a representation of the user's intention and level of understanding by applying one or more classifiers trained on labeled data sets of user utterances categorized by intent class and understanding level. The classifier may be a neural network that consumes as input a sequence of token embeddings and outputs scores for multiple intent categories and understanding-level categories. By structuring the analysis in this way, the server extracts features that are not typically visible in raw text, such as whether the user is hypothesizing, asking for clarification, or restating known facts, and whether the user appears to be a novice or advanced learner with respect to the topic.

The server uses the prompt construction module to construct a first prompt sentence that instructs the generative AI model to generate an additional question to deepen the user's thinking. The server composes this prompt sentence by combining template text with dynamic elements derived from the analysis results. For example, the server may generate a prompt sentence of the form:

“You are a tutoring assistant. Read the user's statement and generate ONE follow-up question that deepens the user's thinking and encourages them to explain the mechanism in more detail. Do not answer the question; only ask a question.

User's statement: ‘I think the mechanism of rain is caused by changes in temperature and humidity.’

Output only the follow-up question.”

The server may adjust the wording of the prompt sentence according to the identified topic, the detected understanding level, and dialog policy parameters stored in the storage device. For instance, if the analysis module detects that the user is a novice, the server modifies the prompt sentence to instruct the generative AI model to use simpler vocabulary and shorter sentences. If the analysis module detects that the user is advanced, the server instructs the generative AI model to ask more challenging, multi-step reasoning questions. By encoding such conditions explicitly in the prompt sentence, the server achieves machine-level control over the generative AI model's behavior.

The server implements the generative AI model as a neural language model configured to generate natural language text. In one embodiment, the generative AI model is a transformer-based neural network including an embedding layer, a plurality of self-attention layers, and an output projection layer. The model receives as input a sequence of token identifiers derived from the prompt sentence and outputs a sequence of probability distributions over a vocabulary at each time step. The server performs greedy decoding or beam search decoding based on these distributions to generate the next token until an end-of-sequence condition is satisfied. The model parameters, including weight matrices of attention layers and feedforward layers, are stored in memory and loaded at runtime. The server trains the generative AI model in advance using a large corpus of text data and dialog data. During training, the server or a training system executes a learning algorithm that minimizes a loss function such as cross-entropy between predicted token distributions and ground-truth tokens. A gradient-based optimization method such as stochastic gradient descent or Adam is used to update the weights. The training pipeline may also include data augmentation, such as paraphrasing of questions, noise injection, and random truncation of dialog contexts, to make the model more robust. By employing such a trained model, the server can generate context-aware follow-up questions and explanatory answers that are difficult to reproduce with simple rule-based systems.

In another embodiment, the server uses a hybrid model in which a smaller local model performs initial filtering of candidate outputs generated by a larger remote generative AI model. The local model may score candidate follow-up questions on criteria such as relevance to the detected topic, alignment with the user's understanding level, and compliance with specified length constraints. By discarding low-scoring candidates before sending data back to the terminal, the server reduces network bandwidth usage and avoids transmitting irrelevant or overly complex outputs.

The server uses the dialog history management module to store a structured representation of the dialog history in the storage device. The dialog history includes, for each turn, fields such as a conversation identifier, a user identifier, a timestamp, the original natural language information, the generated additional question, the user's answer, the generated explanatory answer, and derived features such as topic tags and understanding-level estimates. The server may store the dialog history using a structured data model such as a relational schema or a key-value data structure. By storing dialog events in this manner, the server can quickly reconstruct previous context and compute features over multiple turns, such as the progression of the user's understanding or the frequency of specific topics.

The server uses this dialog history in conjunction with data structures representing dialog policies to reconstruct a second prompt sentence for generating an explanatory answer. For example, the server may construct a second prompt sentence in the form:

“You are a tutoring assistant. The user is learning about the mechanism of rain.

Read the original statement, your previous follow-up question, and the user's new answer.

First, confirm what the user explained correctly. Then, add clear and concise details to deepen their understanding.

Use simple language suitable for a learner.

### Original User Statement:

‘I think the mechanism of rain is caused by changes in temperature and humidity.’

Your previous question:

‘Can you explain more specifically how changes in temperature and humidity cause water vapor to condense into raindrops?’

User's answer:

‘When warm air rises and cools down, the water vapor condenses into small droplets, these droplets gather into clouds, and when they get heavy, they fall as rain.’

Now generate a short explanation that both confirms the user's understanding and supplements it.”

The server may adjust this prompt sentence according to previously recorded information in the dialog history, such as whether previous explanations were too long or too short for the user, or whether the user frequently requested further clarification. The server may maintain, in the storage device, a vector of dialog parameters for each user or conversation, and may update these parameters after each interaction. Examples of such parameters include preferred explanation length, preferred level of detail, and sensitivity to technical terminology.

The server uses the generative AI model interface module to send the constructed prompt sentences to the generative AI model and to retrieve generated outputs. When the model is hosted externally, the server uses the communication module to transmit prompt data to a remote computational node over a network using a secure communication protocol. When the model is hosted locally, the server calls a local inference engine that directly executes forward passes through the neural network. In either case, the interface module manages tokenization of prompt sentences, conversion between text and token sequences, and post-processing of generated token sequences back into text.

The server applies post-processing rules to generated texts before recording them in the dialog history and sending them to the terminal. For example, the server enforces constraints that the additional question must end with a question mark, must not exceed a specified number of characters or tokens, and must not contain disallowed content. The server may compute a quality score for each generated text using auxiliary models or hand-crafted rules and may discard or regenerate outputs that do not meet minimum quality thresholds. By enforcing such machine-checkable constraints, the server ensures that the generative AI model's output is suitable for the target dialog context and reduces the need for multiple retries.

The terminal receives from the server the additional question and explanatory answer and displays them to the user on the display. The terminal arranges messages chronologically in a chat-like interface, and may visually distinguish between user messages and server-generated messages. The terminal may also display meta-information such as timestamps or indicators that a response has been generated by an AI system. The user reads the displayed content and enters further natural language information using the input interface, thereby allowing the dialog to continue.

The described architecture and processing provide technical advantages beyond mere automation of human mental tasks. By performing structured linguistic analysis and dialog policy-aware prompt construction on the server, the system reduces redundant computation by avoiding repeated, uninformed calls to the generative AI model. Because the server uses extracted features such as topic and understanding level, the prompt sentences are shorter and more targeted, which reduces the number of tokens provided to the generative AI model and thereby decreases computation time and resource usage for each inference. The dialog history management enables the server to reuse previously computed representations, avoiding re-analysis of the complete interaction history for each turn, which improves response latency and overall throughput.

Additionally, by dynamically controlling the response content and style of the generative AI model based on the dialog history and linguistic features, the system reduces the need for additional clarification requests and follow-up prompts that would otherwise be required to adapt responses to different users. This reduces network traffic between the server and any external generative AI model host, thereby lowering communication load. The explicit encoding of constraints, output formats, and dialog policies in the prompt sentences also improves determinism and reduces error variance in generated outputs, leading to fewer misaligned responses and less wasted computational effort.

The server uses algorithms and control logic that differ from conventional human-tutoring processes. For example, whereas a human tutor may adjust questions and explanations using tacit knowledge, the server encodes dialog state as explicit numeric vectors, uses classifier outputs as features to choose between pre-defined dialog strategies, and applies rules to modify prompt sentences in a machine-controlled manner. The server may, for example, implement a state machine or reinforcement-learning-based policy that selects whether to ask an additional question or to provide an explanation based on measured changes in the user's estimated understanding. Such a mechanism follows explicit computational rules and makes use of intermediate structures, such as attention-based topic vectors and understanding-level scores, that have no direct counterpart in manual human processing.

In one variation, the server configures the generative AI model to include multiple heads trained for different tasks, such as question generation and explanation generation, and switches heads based on the prompt sentence type. In another variation, the server combines the output of a discriminative classifier with the output of the generative AI model by re-ranking candidate questions or explanations, thereby improving alignment between the generated content and the user's state. These variations illustrate that the system is not limited to a single model configuration and can be adapted to different hardware resources or application requirements while maintaining the same underlying technical concept of prompt-driven, dialog-history-aware control.

In still another embodiment, the server uses a compression mechanism for dialog history, such as summarizing earlier turns using the generative AI model with a specific summarization prompt, and storing the summary instead of the full text. The server may construct a prompt sentence like:

“Summarize the following dialog between a user and an assistant in no more than five sentences, preserving key concepts and the user's understanding progression.”

The server then uses the generated summary as a condensed context for subsequent prompt sentences. This reduces memory usage and token length supplied to the generative AI model, thereby improving computational efficiency and reducing latency, while still preserving essential information needed to tailor further questions and explanations.

Through these configurations and variations, the server implements a specific data flow and control logic in which natural language information is transformed into analysis features, prompt sentences, generated text, and stored dialog structures. This transformation is tightly coupled with the characteristics of the computing hardware and software modules. The system, therefore, achieves technical effects such as faster generation of relevant dialog content, more efficient use of computational and communication resources, improved quality and consistency of AI-generated text outputs, and enhanced adaptability of the dialog behavior to the user's evolving understanding, thereby improving the functioning of the computer-based dialog system itself.

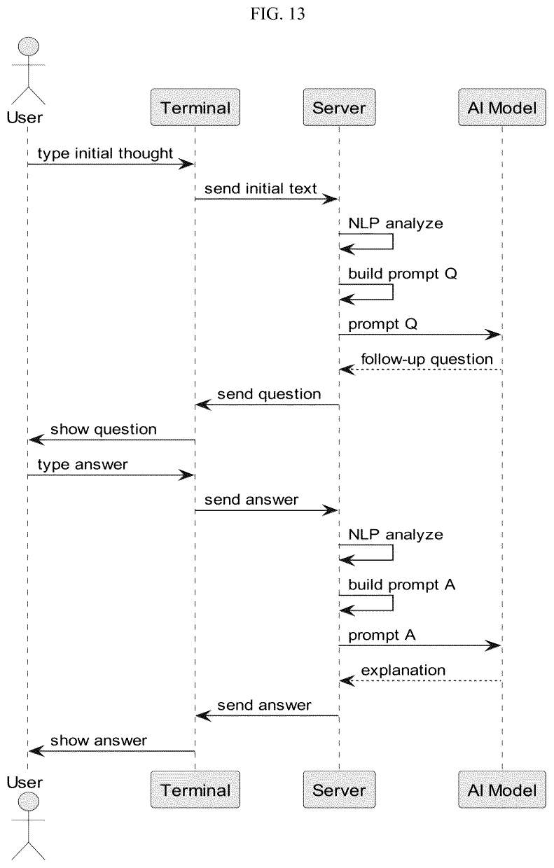

The following describes the processing flow using FIG. 13.

### Step 1

The user operates the terminal and inputs initial natural language information.

The terminal receives, as input, keystrokes or touch events that form a text string, for example: “I think the mechanism of rain is caused by changes in temperature and humidity.”

The terminal converts the user's input events into a UTF-8 encoded text string and temporarily stores this string in an application buffer in memory.

The terminal generates a structured data object including at least the text string, a user identifier, and a conversation identifier as an internal representation to be sent to the server.

The output of this step is a structured user input object containing the natural language text and associated identifiers.

### Step 2

The terminal transmits the structured user input object to the server.

The terminal receives the structured user input object as input and serializes it into a message payload.

The terminal sets communication parameters such as destination address, protocol type, and headers, and then encapsulates the payload in a network packet.

The terminal sends the packet over a communication interface using a communication protocol stack (for example, TCP/IP over Wi-Fi or mobile network) toward the server.

The output of this step is a network message containing the user's natural language information that is delivered to the server.

### Step 3

The server receives the network message and parses the structured user input object.

The server takes, as input, the network packet from the terminal and decapsulates the packet to extract the application-level payload.

The server uses a parsing routine to decode the serialized structured data and reconstructs the user input object containing the text string, user identifier, and conversation identifier.

The server stores this reconstructed object in working memory and optionally logs it to a storage device for dialog history.

The output of this step is an internal representation of the user's natural language information on the server side.

### Step 4

The server performs natural language preprocessing on the user's text.

The server receives, as input, the text string from the user input object.

The server applies tokenization to split the text into tokens and applies normalization operations such as lowercasing or punctuation handling.

The server computes basic statistics such as token count and character length and may detect the language of the text.

The server stores the token sequence and associated statistics as a processed text object.

The output of this step is a processed text object containing tokens, language information, and length metrics.

### Step 5

The server performs syntactic and semantic analysis to extract topics, concepts, and user intention.

The server receives, as input, the processed text object including tokenized text.

The server applies a syntactic analysis algorithm, such as a dependency parser, to compute grammatical relations between tokens and constructs a parse tree.

The server applies a semantic analysis component, such as a classifier or tagger, to identify topic-related nouns and noun phrases, and to compute semantic roles and concept labels.

The server applies an additional classifier, such as a neural network-based intent and understanding-level classifier, that takes as features the token embeddings, part-of-speech tags, and parse-tree structure to estimate an intention category (for example, hypothesis, question, or explanation) and a level-of-understanding category (for example, low, medium, high).

The server aggregates these analysis results into an analysis result object that contains topics, concepts, intention type, and understanding level.

The output of this step is an analysis result object representing a structured understanding of the user's initial input.

### Step 6

The server determines dialog control parameters based on the analysis result object.

The server receives, as input, the analysis result object and any existing dialog parameters stored for the conversation.

The server applies a rule set or policy function that maps the intention type and understanding level to dialog parameters such as depth of follow-up questioning, allowed length of questions, and desired complexity of language.

The server may, for example, select a “basic explanation required” policy for a low understanding level or an “advanced probing” policy for a high understanding level.

The server outputs a dialog parameter object that encodes settings such as target question length, complexity score, and required inclusion of specific extracted concepts in the follow-up question.

The output of this step is a dialog parameter object used for prompt construction.

### Step 7

The server constructs a first prompt sentence to request an additional question from the generative AI model.

The server receives, as input, the analysis result object and the dialog parameter object.

The server selects a base prompt template for follow-up question generation and inserts dynamic values such as the user's original statement, the detected topic, and the desired depth of questioning.

The server modifies the wording of the prompt according to the dialog parameters; for example, it may specify “Use simple language” or “Ask a detailed technical question.”

The server produces a first prompt sentence in natural language, such as:

“You are a tutoring assistant. Read the user's statement and generate ONE follow-up question that deepens the user's thinking and encourages them to explain the mechanism in more detail. Do not answer the question; only ask a question.

User's statement: ‘I think the mechanism of rain is caused by changes in temperature and humidity.’

Output only the follow-up question.”

The output of this step is a first prompt sentence string tailored to the user's state.

### Step 8

The server invokes the generative AI model to generate an additional question.

The server receives, as input, the first prompt sentence.

The server converts the prompt sentence into a sequence of tokens using a tokenizer associated with the generative AI model's vocabulary.

The server supplies the token sequence to the generative AI model inference engine, which executes a forward pass through a neural network architecture such as a transformer to compute probability distributions over possible next tokens.

The server repeatedly selects next tokens (for example, using greedy decoding or beam search) and appends them to a generation buffer until an end-of-sequence condition is met or a maximum token length is reached.

The server converts the generated token sequence back into a text string representing the additional question.

The output of this step is a generated additional question string produced by the generative AI model.

### Step 9

The server post-processes and validates the additional question.

The server receives, as input, the generated additional question string.

The server trims whitespace, normalizes punctuation, and enforces that the question ends with a question mark.

The server validates the length and checks whether required concepts identified earlier (such as “rain,” “temperature,” or “humidity”) are present, based on predefined constraints.

If the generated question fails validation, the server may adjust parameters (such as temperature or length limit) and re-invoke the generative AI model until a valid question is obtained or a retry limit is reached.

The server records the final additional question and its metadata in the dialog history storage associated with the conversation identifier.

The output of this step is a validated additional question entry stored in dialog history and a corresponding text string ready for transmission.

### Step 10

The server prepares and sends a message containing the additional question to the terminal.

The server receives, as input, the validated additional question string and associated identifiers.

The server constructs a response object including the conversation identifier, a role indicator (assistant), a message type (follow-up question), and the question text.

The server serializes this object into a message payload and encapsulates it into a network packet using the communication module.

The server sends the packet via the network interface to the terminal address associated with the conversation.

The output of this step is a network message containing the additional question transmitted from the server to the terminal.

### Step 11

The terminal receives and displays the additional question to the user.

The terminal takes, as input, the network message from the server and decapsulates it to obtain the response payload.

The terminal parses the payload to reconstruct the response object, extracting the additional question text and associated metadata.

The terminal updates the user interface by appending a new message component to the display area, formatting the question text according to display rules (for example, alignment and font style).

The output of this step is a graphical presentation of the additional question on the terminal screen, visible to the user.

### Step 12

The user reads the additional question and inputs an answer via the terminal.

The user visually perceives the displayed question and formulates an answer in natural language.

The user operates the input interface to enter an answer text string, for example: “When warm air rises and cools down, the water vapor condenses into small droplets, these droplets gather into clouds, and when they get heavy, they fall as rain.”

The terminal captures the input events, converts them into a UTF-8 encoded text string, and stores this string in an input buffer.

The output of this step is a new user answer text string stored in the terminal.

### Step 13

The terminal transmits the user's answer and context to the server.

The terminal receives, as input, the user answer string, the conversation identifier, and any relevant prior messages such as the last additional question.

The terminal constructs a structured data object including the user's answer, the conversation identifier, and a reference to the additional question.

The terminal serializes this object, encapsulates it in a network packet, and transmits it to the server using the communication interface.

The output of this step is a network message containing the user's answer and context delivered to the server.

### Step 14:

The server receives and parses the user's answer and updates the dialog history.

The server takes, as input, the network message from the terminal and extracts the payload.

The server parses the structured data object to obtain the answer text string, conversation identifier, and reference to the related additional question.

The server records this information as a new dialog turn in the dialog history storage, associating the user's answer with the corresponding additional question and timestamp.

The output of this step is an updated dialog history entry including the user's answer.

### Step 15

The server analyzes the user's answer using natural language processing.

The server receives, as input, the user's answer text and the existing analysis information from previous turns.

The server applies tokenization, syntactic parsing, and semantic analysis to the answer text to identify key concepts, causal relations, and correctness indicators.

The server may compute a correctness score or coverage score by matching detected concepts in the answer against a reference concept set associated with the topic, such as “warm air rises,” “cooling,” “condensation,” “clouds,” and “raindrops.”

The server updates the understanding-level estimate based on observed improvements or errors by feeding features extracted from the answer into an understanding-level classifier.

The output of this step is an updated analysis result object incorporating the user's answer and revised understanding-level estimate.

### Step 16

The server selects an explanation strategy and dialog policy based on the updated analysis.

The server receives, as input, the updated analysis result object and the dialog parameters stored in the dialog history.

The server compares the current understanding-level estimate with previous values and determines whether the user's understanding has improved, stagnated, or decreased.

The server selects an explanation strategy, such as “confirm and supplement,” “correct misconceptions,” or “provide detailed step-by-step reasoning,” based on changes in the understanding-level estimate and the correctness score.

The server generates an updated dialog parameter object that specifies target explanation length, required inclusion of missing concepts, and appropriate complexity of explanation.

The output of this step is an explanation strategy selection and updated dialog parameters.

### Step 17

The server constructs a second prompt sentence for generating an explanatory answer.

The server receives, as input, the explanation strategy, updated dialog parameters, and relevant dialog history entries including the original statement, the additional question, and the user's answer.

The server selects a base template corresponding to the chosen explanation strategy and inserts the original user statement, the additional question, and the user's answer as quoted sections.

The server encodes in the prompt sentence explicit instructions derived from the dialog parameters, such as “First, confirm what the user explained correctly. Then, add clear and concise details to deepen their understanding. Use simple language suitable for a learner.”

The server produces a second prompt sentence, for example:

“You are a tutoring assistant. The user is learning about the mechanism of rain.

Read the original statement, your previous follow-up question, and the user's new answer.

First, confirm what the user explained correctly. Then, add clear and concise details to deepen their understanding.

Use simple language suitable for a learner.

### Original User Statement:

‘I think the mechanism of rain is caused by changes in temperature and humidity.’

### Your Previous Question:

‘Can you explain more specifically how changes in temperature and humidity cause water vapor to condense into raindrops?’

### User's Answer:

‘When warm air rises and cools down, the water vapor condenses into small droplets, these droplets gather into clouds, and when they get heavy, they fall as rain.’

Now generate a short explanation that both confirms the user's understanding and supplements it.”

The output of this step is a second prompt sentence string prepared for explanation generation.

### Step 18

The server invokes the generative AI model with the second prompt sentence to generate an explanatory answer.

The server receives, as input, the second prompt sentence.

The server tokenizes the prompt, passes the token sequence into the generative AI model, and triggers a forward pass through the neural network layers to compute probability distributions for each subsequent token.

The server decodes tokens iteratively, respecting decoding constraints such as maximum explanation length and target complexity, until an end-of-sequence token or maximum length is reached.

The server converts the generated token sequence back into a natural language text string representing the explanatory answer.

The output of this step is a generated explanatory answer string produced by the generative AI model.

### Step 19

The server post-processes, validates, and stores the explanatory answer.

The server receives, as input, the explanatory answer string.

The server performs text normalization, checks for minimum and maximum length, and verifies that required explanation elements, such as key concepts identified as missing in the user's answer, are included.

The server may compute a readability score and ensure that it falls within a target range appropriate for the user's understanding level.

The server then records the explanatory answer and associated metadata in the dialog history, linking it with the corresponding user answer and additional question.

The output of this step is a validated explanatory answer entry stored in dialog history and a corresponding text string ready for transmission.

### Step 20

The server sends the explanatory answer to the terminal, and the terminal displays it to the user.

The server receives, as input, the validated explanatory answer text and related identifiers, constructs a response object, serializes it, and transmits it to the terminal via the communication module.

The terminal receives the network message, parses the response object, and extracts the explanatory answer text.

The terminal updates the user interface by adding the explanatory answer as a new message display element, formatted according to predetermined style rules for AI-generated explanations.

The output of this step is a visual presentation of the explanatory answer on the terminal, which the user can read to deepen understanding and optionally initiate further dialog.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional dialog systems that use generative artificial intelligence models typically accept a user question, pass it directly to a model with a simple prompt, and return the model's output as a one-shot answer. Such systems suffer from several technical limitations in terms of computer technology itself.

First, the processor generally does not perform structured natural language analysis to extract subjects, question types, and domains, and does not systematically construct context-rich prompt sentences. As a result, the generative model is driven by under-specified input, which causes unstable response quality, unnecessary token usage, and inefficient utilization of computing resources in the model serving infrastructure.

Second, existing systems are not configured to machine-readably separate and structure different functional parts of the generated text, such as explanatory answers versus deepening questions or tasks. Without such structuring, the processor cannot maintain a hierarchically organized history of dialog objects, and the system cannot algorithmically control multi-turn deepening of user thinking. This leads to flat, stateless interactions that do not exploit the full capabilities of the underlying hardware and software stack.

Third, emotion handling, when present at all, is typically implemented as a superficial add-on that merely appends static phrases to a response. The processor usually does not integrate emotion analysis into the prompt-construction pipeline for the generative model. As a consequence, the system cannot use emotional state as a control signal to adjust model behavior, and cannot systematically generate emotion-adapted answers and follow-up questions. This reduces the effectiveness of the dialog engine and wastes the potential of emotion analysis modules and model-serving resources.

Fourth, conventional architectures do not maintain structured, time-ordered histories of answers, deepening questions, and associated emotion states in a form that can be directly utilized by the processor to evaluate dialog depth or to tune prompt strategies. This prevents meaningful feedback loops for improving prompt design and model-calling policies, and limits the technical improvement of the dialog engine over time.

Accordingly, there is a need for a computer-implemented system in which the processor (i) performs detailed natural language analysis of user input, (ii) constructs and manages rich prompt sentences tailored to the generative AI model, (iii) structurally separates and stores generated answers and deepening questions, (iv) integrates emotion analysis into the model-control flow to generate emotion-adapted text, and (v) maintains hierarchical, time-ordered histories to enable systematic evaluation and optimization of dialog behavior. By re-architecting these elements as cooperating computational components, the invention aims to improve the operation of the dialog system as a computer technology, yielding more stable, controllable, and resource-efficient interactions with the generative AI model.

The specific processing by the specific processing unit 290 of the data processing device 12 in Application Example 2 is realized by the following means.

The present invention provides a server comprising a processor configured to receive user input expressed in natural language from a terminal device; to convert the user input into unified character information using at least one of a speech recognition function and a character string processing function; to execute natural language processing including morphological analysis, syntactic analysis, and semantic analysis on the character information so as to identify at least a subject, phrases, a question type, and a related domain contained in the user input; to construct, based on an identification result, a first prompt sentence that specifies content for causing a generative artificial intelligence model to generate at least one of a response to the user input and at least one additional question or task for deepening user thinking; to input the first prompt sentence into the generative artificial intelligence model and acquire generated text including the response and the at least one additional question or task; to identify and separate, by machine processing, the response and the at least one additional question or task from the generated text and to store the at least one additional question or task as a plurality of structured deepening questions; to determine a user emotional state by using an emotion analysis function that estimates the user emotional state based on at least one of user speech information, character information, and image information; to construct, based on the emotional state and the generated text, an additional prompt sentence configured to cause the generative artificial intelligence model to rewrite the response and the at least one additional question or task into an emotion-adapted response and an emotion-adapted additional question including at least one of an empathetic expression and an encouraging expression, and to input the additional prompt sentence into the generative artificial intelligence model so as to acquire emotion-adapted text; and to construct the emotion-adapted response and the emotion-adapted additional question as a response object in a format presentable by a user interface device and to transmit the response object to the terminal device via a communication function. This enables the dialog system to operate as an improved computing mechanism that (i) drives the generative AI model with context-rich, analysis-based prompt sentences, (ii) programmatically separates and structures answers and deepening questions, (iii) uses emotion analysis as a control signal for generation, and (iv) maintains machine-readable dialog histories, thereby enhancing response stability, controllability, and computational efficiency compared to conventional systems.

The term “user input” refers to information expressed in natural language, including at least text or speech, that is provided by a human operator to a terminal device and transmitted to the server for processing.

The term “terminal device” refers to an information processing apparatus, such as a general-purpose computing device or wearable device, that provides an interface for the user to input natural language information and for the user to receive output from the server. The term “server” refers to an information processing apparatus or combination of apparatuses that includes at least one processor and at least one storage device, and that executes programs to perform the functions described herein.

The term “processor” refers to one or more hardware processing units, such as a central processing unit or other execution circuitry, that execute instructions to perform data processing operations defined by software or firmware.

The term “unified character information” refers to textual data in a normalized character encoding format that is obtained by converting speech, raw text, or other input modalities into a common text representation suitable for natural language processing.

The term “speech recognition function” refers to a function executed by hardware and software that converts audio data representing human speech into character information representing the spoken content.

The term “character string processing function” refers to a function executed by hardware and software that receives text data and performs operations such as normalization, encoding conversion, or cleaning to produce character information suitable for analysis.

The term “natural language processing” refers to computational processing of character information that includes at least one of morphological analysis, syntactic analysis, semantic analysis, named-entity recognition, or intent classification.

The term “morphological analysis” refers to a process that segments character information into tokens and determines grammatical categories such as parts of speech and inflected forms.

The term “syntactic analysis” refers to a process that determines structural relationships among tokens in a sentence, including at least one of phrase boundaries and dependency relations.

The term “semantic analysis” refers to a process that infers meanings, roles, or relations from tokens and syntactic structures, including identification of subject matter, entities, and inferred intent.

The term “subject” refers to a main topic or concept contained in the user input, which is identified by natural language processing based on tokens, phrases, and syntactic or semantic relations.

The term “question type” refers to a classification of the user input as a particular kind of inquiry, such as a why-type question, a how-type question, or a what-type question, as determined by natural language processing.

The term “related domain” refers to a technical or conceptual field, such as a scientific field, historical field, or environmental field, that is inferred from the content of the user input by natural language processing.

The term “prompt sentence” refers to a machine-generated natural language instruction string that is constructed by the processor and provided as input to a generative artificial intelligence model in order to control generation behavior.

The term “first prompt sentence” refers to a prompt sentence that is constructed based on an identification result of the user input and that is configured to cause a generative artificial intelligence model to generate at least one response and at least one additional question or task.

The term “additional prompt sentence” refers to a prompt sentence that is constructed based on at least one of an emotional state, a response, and an additional question or task, and that is configured to cause a generative artificial intelligence model to rewrite or adapt generated text.

The term “generative artificial intelligence model” refers to a machine-implemented model, such as a neural network model, trained on data to generate natural language text in response to a prompt sentence.

The term “generated text” refers to natural language text output by the generative artificial intelligence model in response to a prompt sentence, including at least one response and at least one additional question or task.

The term “response” refers to a portion of the generated text that provides an answer, explanation, or other direct reply to the user input.

The term “additional question” refers to a portion of the generated text that is a further inquiry intended to deepen or extend the user's thinking beyond the original user input.

The term “task” refers to a portion of the generated text that instructs the user to perform a cognitive or practical activity that contributes to deeper understanding or reflection.

The term “deepening question” refers to an additional question that is specifically structured to promote more detailed reasoning, exploration of related concepts, or expansion of the user's understanding.

The term “structured deepening questions” refers to one or more deepening questions that are stored in a data structure with explicit fields such as identifiers, hierarchy levels, and temporal order, enabling programmatic retrieval and control.

The term “emotion analysis function” refers to a function executed by hardware and software that estimates a user emotional state based on at least one of speech information, character information, and image information.

The term “user emotional state” refers to a classification or quantitative representation of a psychological condition of the user, such as a positive, negative, neutral, excited, sad, or interested state, as determined by an emotion analysis function.

The term “emotion-adapted response” refers to a response that has been generated or rewritten such that its wording and tone are adjusted based on the user emotional state.

The term “emotion-adapted additional question” refers to an additional question that has been generated or rewritten such that its wording and tone are adjusted based on the user emotional state while maintaining its function of deepening user thinking.

The term “empathetic expression” refers to wording in generated text that acknowledges or reflects the user's emotional state in a manner indicating understanding or sympathy.

The term “encouraging expression” refers to wording in generated text that is configured to motivate, support, or positively reinforce the user in view of the user emotional state.

The term “emotion-adapted text” refers to generated text that includes at least one emotion-adapted response or emotion-adapted additional question, and that has been produced based on a prompt sentence including emotional state information.

The term “response object” refers to a data structure that contains at least one response, at least one additional question or task, and optionally emotional state information, formatted for presentation by a user interface device.

The term “user interface device” refers to a functional component of the terminal device that provides at least one of visual output, audio output, or interactive controls for presenting the response object to the user and receiving subsequent user operations.

The term “communication function” refers to hardware and software components that enable data transmission and reception between the terminal device and the server via a communication network.

The term “storage device” refers to a memory component, such as a volatile memory or non-volatile memory, that stores at least one of user input, generated text, structured deepening questions, emotional states, and response objects.

The term “hierarchically arranged groups of questions or tasks” refers to collections of questions or tasks that are organized into multiple levels, such as main questions and subordinate deepening questions, in a structure indicating logical or temporal relationships.

The term “history information” refers to recorded data that associates user inputs, identification results, emotional states, responses, and deepening questions with time information or session information for later evaluation and analysis.

The term “session information” refers to data indicating at least one of a user identifier, a device identifier, a time stamp, or a dialog context identifier, which associates successive interactions as belonging to a common dialog episode.

The term “learning support use case” refers to an application context in which the system is used to assist a user in acquiring knowledge or skills by generating explanations, deepening questions, and tasks.

The term “education support use case” refers to an application context in which the system is used in structured educational settings to provide adaptive questions, explanations, and emotion-aware feedback to learners.

The term “creative activity support use case” refers to an application context in which the system is used to assist a user in generating, organizing, or refining ideas for projects or creative works by providing deepening questions and tasks.

The term “analysis of performance of the generative artificial intelligence model” refers to processing of history information to evaluate at least one of response quality, stability, relevance, or resource consumption associated with operation of the model. The term “strategies for constructing the prompt sentence” refers to policies, rules, or learned procedures used by the processor to form prompt sentences, including selection of content, structure, and parameters to control behavior of the generative artificial intelligence model.

Server, terminal, and user cooperate to implement embodiments of the invention as described below. Each embodiment is intended to support the scope of the claims and to enable a person skilled in the art to make and use the invention.

Server includes at least one hardware processor, a main memory, a non-volatile storage device, and a network interface. Server executes an operating system such as a general-purpose server OS and a middleware stack including a web server and an application framework. Server further executes a plurality of software modules including a natural language processing module, a generative AI interface module, an emotion analysis interface module, a dialog management module, and a data storage module.

Terminal includes at least one hardware processor, a memory, a display unit, an input unit such as a keyboard, touch panel, or microphone, and a network interface. Terminal executes a client application or web browser that provides a graphical user interface or voice interface to user. Terminal transmits user input to server and receives response objects from server for presentation.

User operates terminal and provides natural language input in the form of text or speech. User may be a learner, an operator in a retail environment, or a creator engaged in a planning task. User views or listens to answers and deepening questions that terminal obtains from server and may select or answer deepening questions to continue the interaction.

Server executes the natural language processing module to convert heterogeneous user input into unified character information and to perform structured linguistic analysis. When user provides speech, terminal captures audio data with a microphone and transmits the audio stream or file to server. Server applies a speech recognition engine, which may be implemented by a recurrent neural network or transformer-based acoustic-language model, to convert the audio into a text sequence encoded in a normalized character set. When user provides text directly, server applies character string normalization routines that unify encoding, remove control characters, and standardize punctuation.

Server then applies morphological analysis, syntactic analysis, and semantic analysis to the unified character information. Server, in one embodiment, uses a statistical or neural sequence-labeling model to assign part-of-speech tags to each token and to identify lemma forms. Server, in another embodiment, uses a dependency parser implemented by a graph-based or transition-based algorithm to compute dependency arcs between tokens. Server identifies subjects, objects, and interrogative structures such as “why”, “how”, or “what” constructs by combining dependency relations and lexical patterns. Server further uses a semantic classifier, such as a feed-forward neural network with a softmax output layer, to assign the user input to one or more domains (for example, scientific, historical, meteorological) based on embeddings of the token sequence. This structured analysis produces an identification result that includes at least a subject representation, a question type label, and a domain label.

Server employs the dialog management module to construct a prompt sentence for a generative AI model based on the identification result. Server stores the identification result in a data structure that includes fields for tokens, dependency graph, domain label, and question type. Server then applies deterministic rules, implemented as templates, to translate this data structure into a natural language instruction string. For example, when the question type is “how” and the domain is “biology”, server selects a template that asks for a step-wise explanation and at least one deepening question. When the domain is “history”, server selects a template that emphasizes causes and consequences.

Server, in one embodiment, constructs a first prompt sentence such as:

“The user asked: ‘How does photosynthesis work?’. First, explain the process of photosynthesis in clear and concise terms appropriate for a middle-school learner. Then generate one additional question that helps the user think more deeply about the conditions required for photosynthesis.”

Server, in another embodiment, constructs a prompt sentence for a historical question such as:

“The user asked: ‘Why did World War II start?’. Generate a deeper follow-up question that focuses on political or economic causes and that encourages the user to analyze multiple factors.”

Server formats the prompt sentence as a plain text sequence and passes it to the generative AI interface module.

Server connects the generative AI interface module to a generative AI model that is implemented as a large-scale neural sequence model. The generative AI model, in one embodiment, has a transformer architecture with multiple self-attention layers, feed-forward layers, and layer normalization. The model receives the prompt sentence tokenized into subword units and maps the token sequence into contextual embeddings using positional encodings and stacked attention blocks. The model decodes an output token sequence using autoregressive sampling controlled by parameters such as temperature, top-k or top-p thresholds, and maximum token length. During training, model parameters are optimized by minimizing a cross-entropy loss between predicted tokens and ground-truth tokens on large corpora of natural language text, using gradient-based optimization such as Adam. During inference, server supplies a prompt sentence and the model generates continuation tokens that form the generated text.

Server communicates with the generative AI model by sending the prompt sentence and generation parameters to the model via a network protocol or an internal API. Server, after receiving the generated text, applies parsing rules to separate different functional segments within the generated text. Server, in one embodiment, instructs the model via the prompt to label segments using keywords such as “Answer:” and “Question:”. Server then splits the generated text at these labels and extracts a response segment and at least one additional question segment.

Server stores the additional questions in a structured form. The data storage module represents each additional question as a record having fields including a question identifier, a parent question identifier, a hierarchy level, a timestamp, and text content. Server aggregates multiple additional questions into a tree or directed acyclic graph that represents hierarchical relationships among main questions and deepening questions. This structure allows server to reconstruct a dialog history, traverse the tree to select appropriate follow-ups, and compute metrics regarding depth of exploration.

Server also executes the emotion analysis interface module to determine a user emotional state, which then serves as an additional control signal for the generative AI model. When terminal provides speech, server extracts acoustic features such as fundamental frequency, energy, spectral centroid, and formant characteristics from the audio signal. Server feeds these features into an emotion classification network, for example a convolutional-recurrent neural network trained to output probability distributions over emotion categories such as positive, neutral, and negative. When terminal provides text, server computes text embeddings and applies a sentiment classifier that has been trained with labels representing emotions. When terminal provides images, such as video frames from a camera, server detects a face region using a convolutional neural network, extracts facial landmarks, and applies a classifier trained to map landmark configurations to emotion categories.

Server aggregates emotion predictions from different modalities by averaging probabilities or applying a learned fusion network. This process yields a user emotional state label, such as “sad”, “interested”, or “excited”, which server associates with the current user input and stores in the dialog history.

Server utilizes the emotional state to construct an additional prompt sentence that adapts the wording and tone of the response and deepening questions. Server, for example, creates a prompt sentence such as:

“Base answer: ‘It will rain tomorrow.’ User emotion: ‘excited’. Rewrite this answer in a friendly and encouraging tone, maintaining the factual content, and include one short sentence that supports the user's positive mood.”

Server may also create a prompt sentence such as:

“Base answer: ‘Rain occurs when water vapor condenses in the atmosphere and falls as droplets.’ User emotion: ‘worried’. Rewrite this answer using empathetic expressions that acknowledge the user's concern about bad weather, and maintain technical accuracy.”

Server passes such additional prompt sentences to the same generative AI model or to a smaller rewriting model. The model then generates emotion-adapted text. Server replaces the base response and additional questions with their emotion-adapted counterparts and stores these in the response object.

Server constructs a response object as a data structure that includes at least (i) an answer field, (ii) one or more deepening question fields, (iii) an emotional state field, and optionally (iv) metadata such as timestamps and domain labels. Server encodes this structure in a format suitable for transmission, such as a serialized object or structured message. Server then transmits the response object to terminal via the communication function.

Terminal receives the response object and displays the answer and deepening questions according to a user interface design. Terminal may display the answer in a main region and list the deepening questions as selectable items. Terminal may indicate the emotional adaptation by using color, icons, or short text hints. Terminal may additionally convert the answer and one deepening question to audio using a text-to-speech engine and output them via a speaker.

User may select one deepening question, type a new question, or speak a follow-up query. Terminal captures this interaction and forwards it to server as new user input. Server associates the new input with a node in the question tree and updates the hierarchical structure accordingly. This enables server to track how deeply a user explores a topic and to tailor subsequent prompts to increase or decrease depth as needed.

Server reduces computational load and improves response quality by leveraging the structured analysis and history. For example, server caches domain-specific prompt templates and reuses them across similar questions, reducing prompt construction time. Server also adapts generation parameters such as maximum token length based on question type and prior depth, thereby reducing unnecessary token generation and network traffic. When server identifies repeated patterns indicating that a user has already received sufficient depth on a subtopic, server biases prompt templates toward summarization or topic transition, improving user experience and resource efficiency.

Server improves accuracy and stability of dialog responses because the prompt sentences are constructed from explicit features (subject, question type, domain, emotional state) rather than raw user text alone. This explicit control reduces variance in model behavior and mitigates failures that can occur when a generative AI model is driven by unstructured, ambiguous prompts. The hierarchical storage of questions and answers provides a concrete data structure for analyzing dialog trajectories and tuning prompt strategies. Server can, for example, compute statistics on which deepening questions lead to more extended dialog branches and adjust templates to favor such questions.

Server implements training and updating of the underlying emotion models and auxiliary classifiers in a way that further enhances technical performance. For example, server uses supervised learning with annotated corpora of emotional speech, text, and facial expressions. Server minimizes a loss function that includes both classification loss and regularization terms, and updates network weights using backpropagation. Server, in some embodiments, applies data augmentation such as adding noise to audio signals, changing pitch, or varying illumination in images to improve model robustness. Because the emotion analysis is integrated into the prompt generation pipeline, improvements in emotion classification yield measurable improvements in user-appropriate responses and thus in overall system performance.

Server can be configured in alternative embodiments. In one embodiment, server executes all natural language processing and generative AI functions locally on dedicated hardware accelerators such as graphics processors or tensor accelerators. This embodiment is suitable for environments emphasizing low latency and data privacy. In another embodiment, server acts as an orchestrator that calls external generative AI services and emotion analysis services over a network while maintaining the dialog management and history storage locally. In both cases, the core logic of constructing prompt sentences based on structured analysis and emotional state remains the same.

Server may employ different architectural variants of the generative AI model. In one variant, server uses a single large model for both answering and rewriting. In another variant, server uses a pair of models, one tuned for domain-specific answering and one tuned for style adaptation based on emotion. In yet another variant, server uses a smaller on-device model at terminal for preliminary rewriting when network conditions are poor, and synchronizes with a larger server-side model when bandwidth permits. These variations illustrate that the claimed system is not limited to a particular provider or deployment, but rather to the cooperative behavior defined by the processor configurations.

Terminal may also differ between embodiments. In one embodiment, terminal is a mobile computing device that displays text and plays audio. In another embodiment, terminal is a head-mounted display used by a store clerk. In that embodiment, terminal displays short emotion-adapted suggestions in the field of view of the clerk, who then speaks them to a customer. This configuration shows a direct coupling between the internal computer processing and real-world human interaction: the structured dialog management and emotion-adapted prompt control enable terminal to present suitable messages quickly without requiring the clerk to manually search or infer appropriate wording.

User benefits from improved computer technology rather than mere automation of a human activity. A conventional human tutor might generate questions and empathic responses manually, but cannot exploit a large-scale generative AI model or hierarchical question structures at machine speed. In contrast, server executes non-conventional processing steps that include structured linguistic analysis, emotion-aware prompt construction, generative model control via prompt sentences, machine-readable segmentation of generated text, and hierarchical history management. These steps, together, produce technical effects such as reduced processing latency, improved accuracy of domain-specific answers, decreased variance in generative outputs, and lower network bandwidth consumption due to controlled token generation.

Server, by designing prompt sentences using explicit intermediate data structures and emotional state information, imposes a machine-implemented control policy on the generative AI model. This control policy is distinct from human mental processes and is expressed as deterministic or learned rules operating on vectorized representations, parse trees, and emotion labels. Because the dialog management logic exploits data structures and algorithms tailored to the capabilities and limitations of the generative AI model, the system as a whole exhibits an improvement in the functioning of the computer itself, as measured by resource usage and response stability.

In summary, server, terminal, and user interact through concrete hardware and software components that cooperate to implement the claimed system. Server uses natural language processing, generation control via prompt sentences, emotion analysis, and structured dialog storage to transform unstructured user input into emotion-adapted answers and deepening questions in a technically efficient manner. Terminal presents these results to user, and user continues the interaction, enabling the system to iteratively deepen understanding. Various embodiments, including different model architectures, deployment configurations, and user interface forms, all remain within the scope of the claims so long as server is configured to perform the defined processing with respect to user input, prompt sentence construction, generative AI model control, and emotion-aware dialog management.

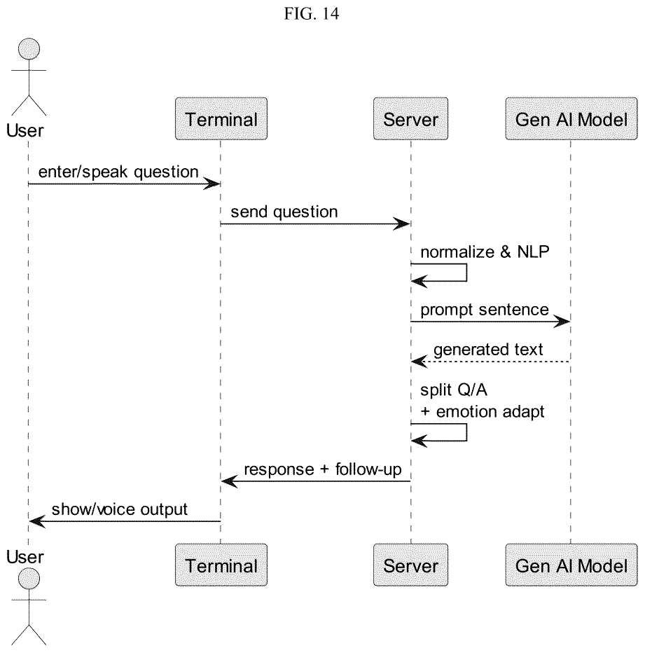

The following describes the processing flow using FIG. 14.

### Step 1

User operates the terminal and provides initial input.

User opens an application or web page on the terminal and enters a question in natural language, for example by typing “How does photosynthesis work?” or by speaking the same sentence into a microphone.

Input: human speech signal or raw text characters.

Output: digital text or audio data stored in terminal memory.

Terminal, when receiving speech, samples the audio via a microphone, converts it into an audio stream (for example, 16-bit PCM), and buffers this data. Terminal, when receiving typed text, stores the character sequence in an internal buffer.

### Step 2

Terminal transmits the user input to the server.

Terminal constructs a request message that contains either the text question or the recorded audio data together with metadata such as a session identifier and a timestamp.

Input: buffered text or audio data and session metadata.

Output: a network request containing the user input sent to the server.

Terminal encodes the text in a standardized character encoding and encapsulates the data into a network packet, then uses a communication stack to send the packet to the server over a communication network.

### Step 3

Server receives and normalizes the user input.

Server, through a network interface, receives the request from the terminal and extracts the payload containing the user input.

Input: network packet containing text or audio and metadata.

Output: normalized character information representing the user question.

Server, when the payload contains audio, calls a speech recognition function to convert the audio samples into a text sequence by applying acoustic and language models.

Server, when the payload already contains text, applies character string processing operations such as encoding conversion, whitespace normalization, and removal of control characters so that the result is unified character information suitable for further analysis.

### Step 4

Server performs natural language processing on the normalized text.

Server supplies the unified character information to a natural language processing module that executes tokenization, morphological analysis, syntactic analysis, and semantic analysis.

Input: unified character information (normalized text).

Output: an identification result including tokens, part-of-speech tags, dependency relations, subject representation, question type label, and domain label.

Server segments the text into tokens, assigns part-of-speech tags to each token using a sequence-labeling algorithm, constructs a dependency tree to determine grammatical relations, and applies a classifier to map the text to a domain category such as “biology” or “history.” Server derives a question type (for example, “how-type question”) from interrogative words and sentence structure and stores all these results in a structured data object.

### Step 5

Server constructs a first prompt sentence for the generative AI model.

Server uses the identification result and a set of prompt templates to build a natural language instruction string that will be input to the generative AI model.

Input: identification result (subject, question type, domain, original text).

Output: first prompt sentence as a natural language string.

Server selects a template based on the question type and domain, fills template slots with the original question and suitable explanation level, and generates a prompt sentence such as: “The user asked: ‘How does photosynthesis work?’. First, explain the process of photosynthesis in clear and concise terms appropriate for a middle-school learner. Then generate one additional question that helps the user think more deeply about the conditions required for photosynthesis.” Server stores this prompt sentence for the next processing step.

### Step 6

Server calls the generative AI model with the first prompt sentence.

Server passes the prompt sentence and generation parameters to a generative AI model that implements a transformer-based sequence generator.

Input: first prompt sentence and generation parameters (for example, maximum length, temperature).

Output: generated text containing at least a response segment and an additional question or task segment.

Server encodes the prompt sentence as a sequence of tokens and sends these tokens to the model. The model transforms the tokens through multiple attention and feed-forward layers and computes output token probabilities at each time step. Server samples output tokens according to the specified parameters to form the generated text and then decodes the token sequence back into character information.

### Step 7

Server separates and structures the response and additional questions.

Server analyzes the generated text to distinguish the answer from the deepening question or task.

Input: generated text from the generative AI model.

Output: response text and one or more structured deepening questions.

Server uses delimiter patterns or labels that were requested in the prompt (for example, “Answer:” and “Question:”) to split the generated text into segments. Server assigns the first segment to a response field and subsequent segments to deepening question fields. Server encapsulates each deepening question in a record with identifiers, hierarchy level, and timestamp, thus creating structured deepening questions stored in a question tree or similar data structure.

### Step 8

Server determines the user emotional state.

Server obtains additional user information such as speech prosody, text sentiment, or facial expression data, depending on what the terminal transmitted.

Input: at least one of audio features, text features, or image features associated with the user input.

Output: a user emotional state label or score.

Server extracts numerical features from the input (for example, pitch contours from audio, embedding vectors from text, facial landmark coordinates from images) and feeds them into an emotion analysis function, which computes probabilities for multiple emotion categories. Server selects the emotion with the highest probability or computes a weighted label and associates this emotional state with the current dialog entry.

### Step 9

Server constructs an additional prompt sentence for emotion adaptation.

Server prepares a new natural language instruction that instructs the generative AI model to adapt wording of the response and deepening questions according to the emotional state.

Input: base response text, deepening questions, and emotional state label.

Output: additional prompt sentence for emotion-adapted rewriting.

Server composes a prompt sentence such as: “Base answer: ‘It will rain tomorrow.’ User emotion: ‘excited’. Rewrite this answer in a friendly and encouraging tone, maintaining the factual content, and keep the length similar.” or “Base answer: ‘Rain occurs when water vapor condenses in the atmosphere and falls as droplets.’ User emotion: ‘worried’. Rewrite this answer with empathetic expressions that acknowledge the user's concern while preserving technical accuracy.” Server stores this additional prompt sentence.

### Step 10

Server calls the generative AI model for emotion-adapted text.

Server provides the additional prompt sentence to the generative AI model to generate rewritten output that reflects the emotional state.

Input: additional prompt sentence for emotion adaptation.

Output: emotion-adapted text containing an emotion-adapted response and optionally emotion-adapted deepening questions.

Server tokenizes the additional prompt sentence, feeds the tokens into the generative model, and obtains a new generated token sequence. Server decodes this sequence into text and parses it to extract the rewritten response and, when requested, rewritten deepening questions. Server replaces the original response and questions with these emotion-adapted versions.

### Step 11

Server composes a response object.

Server aggregates the emotion-adapted response, structured deepening questions, emotional state, and metadata into a single data structure suitable for transmission to the terminal.

Input: emotion-adapted response, emotion-adapted deepening questions, emotional state, and dialog identifiers.

Output: response object formatted for presentation by the terminal.

Server creates a record that contains fields for the primary answer, a list of deepening questions with hierarchy information, an emotional state indicator, and time information. Server serializes this record using a predefined schema, ensuring that the terminal can parse and display each component correctly.

### Step 12

Server transmits the response object to the terminal.

Server uses its communication function to send the response object back to the terminal associated with the user session.

Input: serialized response object.

Output: network message containing the response object delivered to the terminal.

Server encapsulates the serialized data in a response message, attaches appropriate headers, and forwards the message through the network interface. Server may also log the transmission event and store the response object in persistent storage as part of the dialog history.

### Step 13

Terminal receives and presents the response to the user.

Terminal obtains the response object from the server and interprets its fields to update the user interface.

Input: response object transmitted by the server.

Output: visual and/or audio presentation of the answer and deepening questions.

Terminal deserializes the response object, extracts the answer text, and renders it in a primary display region. Terminal lists the deepening questions as selectable elements, for example as buttons or menu entries. Terminal, when configured for audio output, uses a text-to-speech engine to synthesize speech from the answer and one deepening question and outputs the synthesized audio via a speaker.

### Step 14

User interacts with the deepening questions to continue the dialog.

User reads or listens to the answer and reviews the deepening questions presented by the terminal.

Input: displayed answer and deepening questions.

Output: new user selection or new user question.

User may tap a particular deepening question, state “Tell me more about the conditions for photosynthesis,” or type a follow-up question. These user actions generate new input at the terminal, which the terminal captures as a new question and processes again beginning from Step 1, thereby enabling iterative deepening of user understanding under the control of the server and the generative AI model driven by prompt sentences.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

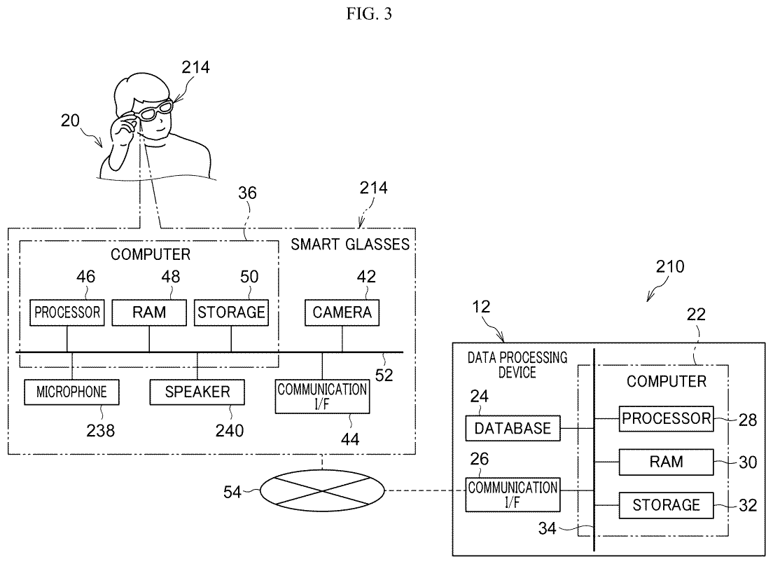

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

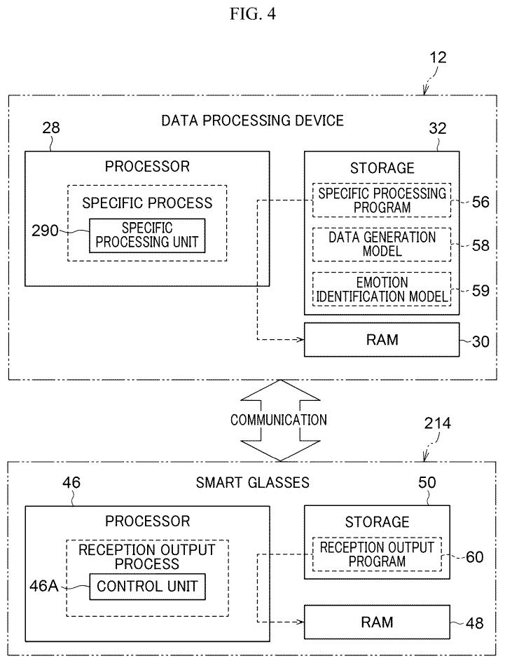

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible. The above exemplary embodiment gives an implementation example in which the specific processing is performed by the data processing device 12, however technology disclosed herein is not limited thereto, and the specific processing may be performed by the smart glasses 214.

### Third Exemplary Embodiment

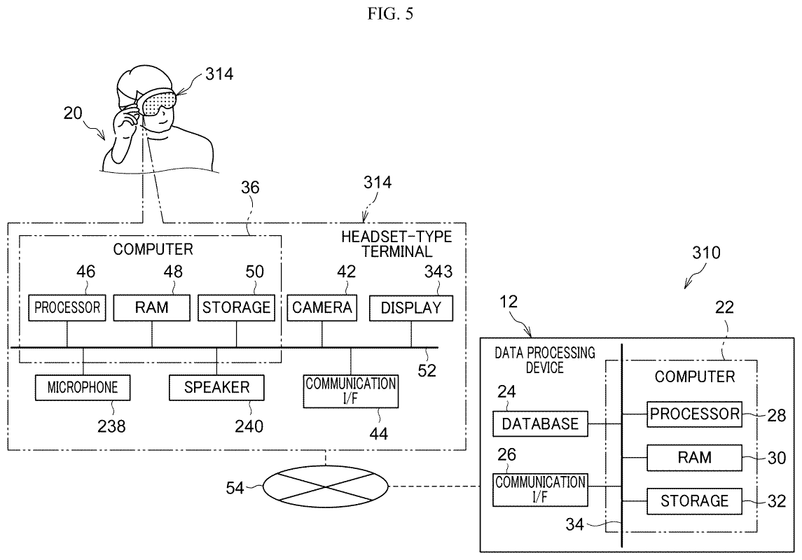

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

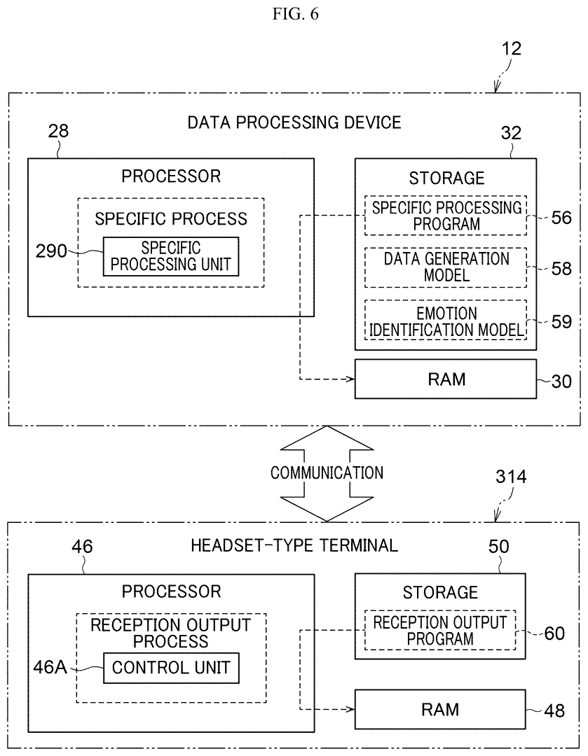

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

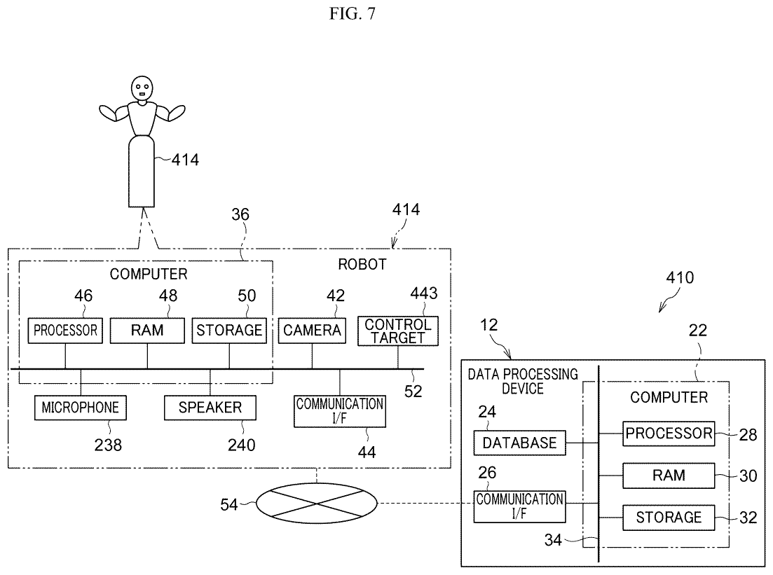

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

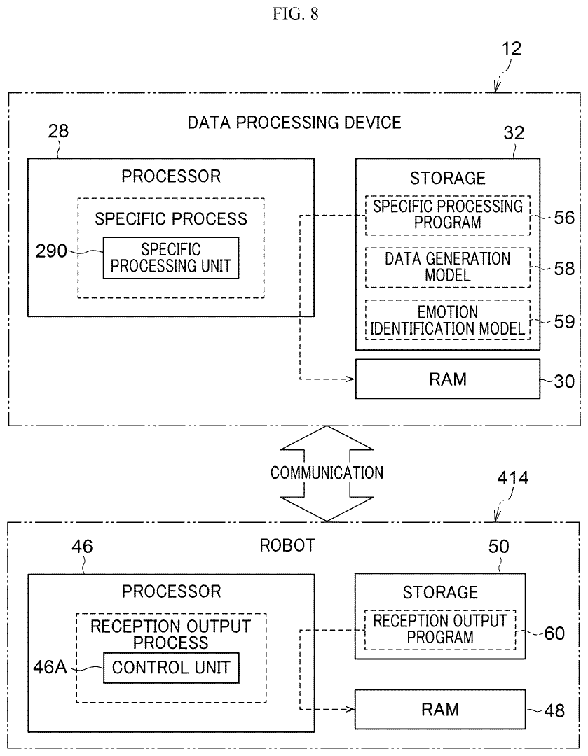

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like.

The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

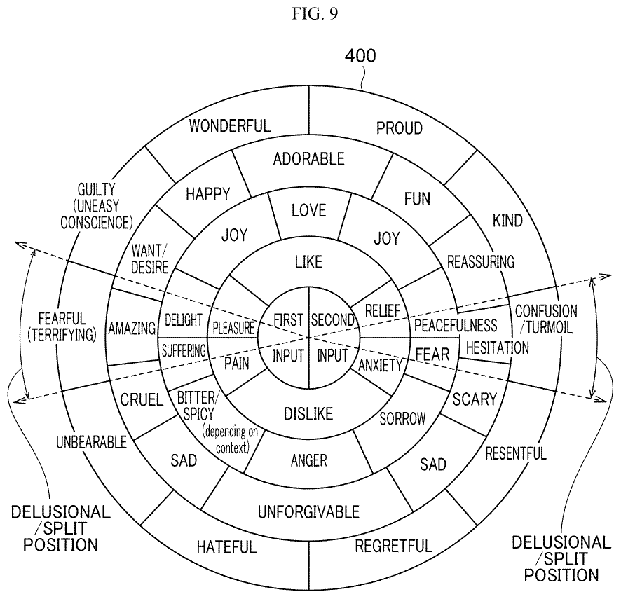

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot. FIG. 9 is a diagram illustrating an emotion map 400 mapping plural emotions. In

the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

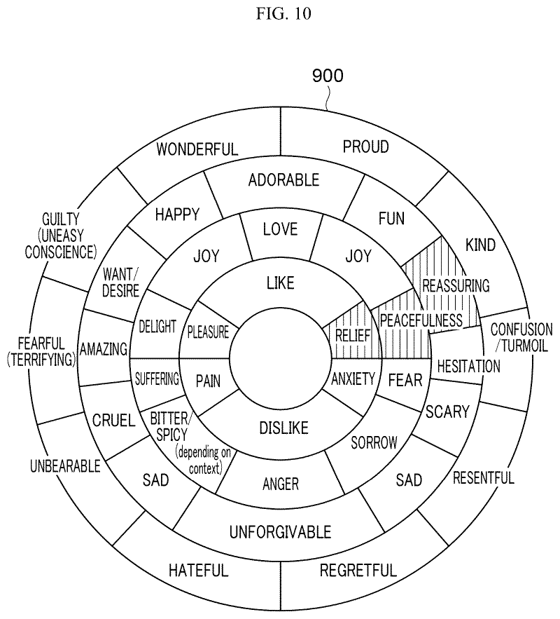

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
receive, from a user via a terminal device, a question expressed in natural language and acquire the question as digital character information,
perform natural language processing on the acquired question, the natural language processing including at least morphological analysis, syntactic analysis, and contextual understanding, to identify an intent and elements of the question and to generate analysis information including a result of the identification,
generate, based on the analysis information, a prompt sentence including operation conditions and output conditions for a generative AI model so as to cause the generative AI model to generate, in natural language, an additional question that deepens the user's thinking, and generate inquiry data including the prompt sentence for input to the generative AI model,
transmit the inquiry data to the generative AI model via a communication path and acquire, from the generative AI model, an additional question expressed in natural language and output by the generative AI model in response to the prompt sentence,
perform post-processing on the acquired additional question, the post-processing including at least determining that the additional question is an interrogative sentence, normalizing a format of the additional question, and filtering contents of the additional question, to generate presentation question data that is presentable to the user, and
transmit the presentation question data to the terminal device and cause the additional question to be presented to the user via the terminal device.

### Supplementary 2

The system according to supplementary 1,
wherein the processor is configured to
cause the generative AI model to receive the inquiry data including the prompt sentence as input, and, by neural network based natural language generation processing, generate a sequence of follow-up questions that promote the user's thinking without including a direct answer to an original question from the user, and select, as the additional question, at least one of the generated follow-up questions that satisfies a predetermined condition.

### Supplementary 3

The system according to supplementary 1,
wherein the processor is configured to
control the terminal device to display the presentation question data in a dialogue-type display area in association with the original question from the user in chronological order, and, upon receiving new input from the user via the terminal device, treat the new input as a next question for deepening the user's thinking and repeat generation of the additional question so as to provide an iterative dialogue.

### Application Example 1

### Supplementary 1

A system comprising a processor,
wherein the processor is configured to
receive audio information obtained from a user as input and convert the audio information into a character string representing a question from the user by using a speech recognition function for converting audio information into character information,
perform syntactic analysis and semantic analysis on the character string representing the question from the user by using an information processing function that implements natural language processing technology, identify an intent and a subject of the question, and generate structured data including the intent and the subject,
generate a prompt sentence to be input to a generative AI model having a generative language processing function, based on the structured data and the character string representing the question from the user, and cause the generative AI model to generate, in a natural language, an additional question for deepening thinking of the user by inputting the prompt sentence to the generative AI model,
obtain the additional question output from the generative AI model and present the additional question to the user by using a visual display device having a display function, and
sequentially obtain responses of the user to the additional question by using the speech recognition function and the natural language processing technology, update the structured data, and regenerate and sequentially input the prompt sentence to the generative AI model, thereby continuously executing a dialogue for stepwise deepening of the thinking of the user.

### Supplementary 2

The system according to supplementary 1,
wherein the processor is configured to generate the prompt sentence for input to the generative AI model by a process of concatenating a text template including the intent of the question, the subject of the question, and information relating to an expected effect or a usage scene for the user, with the character string representing the question from the user.

### Supplementary 3

The system according to supplementary 1,
wherein the processor is configured to cause the visual display device including a portable information terminal or a head-mounted display device to present the additional question to the user by overlay-displaying the additional question on a screen of the portable information terminal or the head-mounted display device.

### Example 2

### Supplementary 1

A system comprising a processor,
wherein the processor is configured to
receive, from a terminal, natural language information provided by a user, perform syntactic analysis or semantic analysis on the received natural language information by using a natural language processing technique so as to extract a topic or a concept included in the natural language information and to identify an intention or a level of understanding of the user,
construct a prompt sentence including operation conditions and a response format for a generative artificial intelligence model, based on the identified intention or level of understanding and the extracted topic or concept, so as to cause the generative artificial intelligence model to generate an additional question for deepening the user's thinking, input the constructed prompt sentence to the generative artificial intelligence model and cause the generative artificial intelligence model to generate, in natural language, the additional question,
present the generated additional question to the user via the terminal and receive, from the terminal, an answer of the user to the additional question,
reconstruct, based on a dialogue history including at least a part of the received natural language information, the additional question, and the user's answer, a prompt sentence for causing the generative artificial intelligence model to generate an explanatory answer that promotes understanding by the user, and cause the generative artificial intelligence model to generate, in natural language, the explanatory answer, and
present the generated explanatory answer to the user via the terminal.

### Supplementary 2

The system according to supplementary 1,
wherein the processor is configured to
store the natural language information provided by the user, the generated additional question, the user's answer, and the generated explanatory answer in a storage device in association with identification information and time information, and update the prompt sentence based on the stored dialogue history so as to dynamically control response content or a response style of the generative artificial intelligence model in accordance with a depth of the user's thinking or the level of understanding of the user.

### Supplementary 3

The system according to supplementary 1,
wherein the processor is configured to
change a constraint condition, an output format, or a dialogue policy included in the prompt sentence to be input to the generative artificial intelligence model, in accordance with at least one of a topic, a keyword, a text length, and a writing style calculated as an analysis result by the natural language processing technique, thereby causing the generative artificial intelligence model to generate both the additional question for deepening the user's thinking and the explanatory answer for promoting the user's understanding.

### Application Example 2

### Supplementary 1

A system comprising a processor,
wherein the processor is configured to
receive, from a terminal device, user input expressed in natural language; and convert the user input into unified character information by using at least one of a speech recognition function and a character string processing function; and
perform natural language processing including morphological analysis, syntactic analysis, and semantic analysis on the character information to identify at least a subject, phrases, a question type, and a related domain contained in the user input; and
construct, based on an identification result, a prompt sentence that specifies content for causing a generative artificial intelligence model to generate at least one of a response to the user input and an additional question or task for deepening user thinking; and
input the prompt sentence into the generative artificial intelligence model and acquire generated text including the response and the additional question or task; and
identify and separate the response and the additional question or task from the generated text, and store the additional question or task as a plurality of structured deepening questions; and
determine a user emotional state by using an emotion analysis function that estimates the user emotional state based on at least one of user speech information, character information, and image information; and
generate an additional prompt sentence based on the emotional state and the generated text, the additional prompt sentence being configured to cause the generative artificial intelligence model to rewrite the response and the additional question or task into an emotion-adapted response and an emotion-adapted additional question including at least one of an empathetic expression and an encouraging expression, and input the additional prompt sentence into the generative artificial intelligence model to acquire emotion-adapted text; and
construct the emotion-adapted response and the emotion-adapted additional question as a response object in a format presentable by a user interface device, and transmit the response object to the terminal device via a communication function.

### Supplementary 2

The system according to supplementary 1,
wherein the processor is configured to
store, in a storage device, the response and the additional question or task acquired from the generative artificial intelligence model as hierarchically arranged groups of questions or tasks in accordance with at least one use case selected from a learning support use case, an education support use case, and a creative activity support use case, and manage the stored groups as history information that enables evaluation of at least one of a degree of user understanding and a depth of user thinking.

### Supplementary 3

The system according to supplementary 1,
wherein the processor is configured to
log, in a storage device, the user input, the identification result obtained by the natural language processing, the emotional state, and the response object in association with session information, and to provide the logged information for analysis of performance of the generative artificial intelligence model and improvement of strategies for constructing the prompt sentence.

What is claimed is:

1. A system comprising:
circuitry configured to:
acquire, via a communication interface coupled to a packet-switched network, input query data expressed in natural language from a terminal device;
execute a natural language processing operation on the input query data, the natural language processing operation comprising morphological analysis, syntactic parsing, and contextual interpretation, to generate analysis data comprising an intent classification and extracted semantic elements of the input query data;
construct a constrained instruction sequence based on the analysis data, the constrained instruction sequence comprising the intent classification, the extracted semantic elements, operation condition parameters, and output condition parameters specifying that a generative neural network model is to generate an interrogative output that addresses underlying reasoning related to the input query data without providing a direct answer;
input the constrained instruction sequence into the generative neural network model comprising a transformer-based architecture and acquire generated follow-up query data from the generative neural network model;
execute a post-processing operation on the generated follow-up query data, the post-processing operation comprising an interrogative sentence verification operation, a format normalization operation, and a content filtering operation, to produce validated presentation data; and
transmit the validated presentation data to the terminal device via the communication interface.

2. The system according to claim 1, wherein the circuitry is further configured to:
perform the morphological analysis by segmenting the input query data into token units and assigning part-of-speech tags to each token unit, perform the syntactic parsing by constructing a dependency tree representing grammatical relationships among the token units, and perform the contextual interpretation by computing embedding vectors for the token units using a language model and classifying the intent based on the embedding vectors.

3. The system according to claim 2, wherein the circuitry is further configured to:
extract the semantic elements by identifying subject entities, predicate relations, and object entities from the dependency tree, and classify the input query data into a query type category selected from a plurality of predefined query type categories based on structural patterns in the dependency tree and the intent classification.

4. The system according to claim 3, wherein the constrained instruction sequence further comprises:
a query type parameter derived from the query type category, a depth level parameter indicating a degree of abstraction for the generated follow-up query data, and a prohibition condition specifying that the generative neural network model is not to generate output containing a factual answer to the input query data.

5. The system according to claim 1, wherein the circuitry is further configured to:
cause the generative neural network model to generate a plurality of candidate follow-up query sequences, evaluate each candidate follow-up query sequence against a relevance criterion based on semantic similarity to the extracted semantic elements and a diversity criterion based on lexical distance among the candidate sequences, and select at least one candidate follow-up query sequence satisfying both criteria as the generated follow-up query data.

6. The system according to claim 1, wherein the post-processing operation further comprises:
the interrogative sentence verification operation configured to parse the generated follow-up query data and verify that each sentence terminates with an interrogative marker and contains an interrogative structure, the format normalization operation configured to standardize punctuation, capitalization, and token spacing, and the content filtering operation configured to remove sentences that contain a direct answer pattern matching the extracted semantic elements of the input query data.

7. The system according to claim 1, wherein the circuitry is further configured to:
acquire subsequent input data from the terminal device in response to the validated presentation data, append the subsequent input data and the validated presentation data to a dialogue history stored in an information storage device, and construct a subsequent constrained instruction sequence incorporating the dialogue history to generate further follow-up query data, thereby implementing an iterative dialogue loop.

8. The system according to claim 7, wherein the circuitry is further configured to:
compute a dialogue depth metric based on a number of exchange cycles in the dialogue history, and adjust the depth level parameter in the subsequent constrained instruction sequence as the dialogue depth metric increases to cause the generative neural network model to generate progressively more abstract or foundational follow-up queries.

9. The system according to claim 1, wherein the generative neural network model comprises:
an embedding layer configured to convert input tokens into multidimensional tensor representations, a positional encoding module, a plurality of transformer layers each comprising multi-head self-attention and feed-forward sublayers with layer normalization, and a decoding stage configured to generate a probability distribution over a vocabulary and select output tokens using a sampling strategy.

10. The system according to claim 9, wherein the circuitry is further configured to:
set inference parameters for the generative neural network model comprising a temperature value and a maximum token count, and adjust the temperature value based on the query type category such that a higher temperature value is applied for query type categories associated with creative or exploratory reasoning.

11. The system according to claim 7, wherein the circuitry is further configured to:
acquire evaluation data from the terminal device indicating a usefulness assessment of the validated presentation data, compute a reward signal based on the evaluation data, and update weighting parameters of the operation condition parameters and the output condition parameters using a reinforcement learning operation based on the reward signal to improve relevance of subsequently generated follow-up query data.

12. The system according to claim 1, wherein the circuitry is further configured to:
retrieve, from an information storage device, domain knowledge data associated with a topic identified in the extracted semantic elements, and include the domain knowledge data in the constrained instruction sequence as supplemental context to improve specificity of the generated follow-up query data.

13. The system according to claim 1, wherein the circuitry is further configured to:
acquire audio data from the terminal device, convert the audio data into text data using a speech recognition neural network, and use the text data as the input query data for the natural language processing operation.

14. The system according to claim 7, wherein the circuitry is further configured to:
generate a dialogue summary by applying a summarization operation to the dialogue history stored in the information storage device, and transmit the dialogue summary to the terminal device upon a request from the terminal device or upon the dialogue depth metric exceeding a predetermined threshold.

15. The system according to claim 1, wherein the circuitry is further configured to:
classify the input query data into a difficulty level based on a complexity metric computed from a number of semantic elements and a depth of the dependency tree, and include the difficulty level in the constrained instruction sequence to adjust a sophistication level of the generated follow-up query data.

16. The system according to claim 1, wherein the circuitry is further configured to:
maintain a user interaction profile in an information storage device comprising historical query type distributions and preferred depth levels derived from prior sessions, and incorporate the user interaction profile into the constrained instruction sequence to personalize the generated follow-up query data.

17. The system according to claim 7, wherein the input query data comprises a learning question from a student, the generated follow-up query data comprises Socratic follow-up questions designed to promote reflective thinking and hypothesis formation, the dialogue history records an educational tutoring session, and the iterative dialogue loop implements a guided learning interaction in which the system progressively leads the user toward deeper conceptual understanding without providing direct answers.

18. A system comprising:
circuitry configured to:
acquire input query data in natural language from a terminal device via a communication interface coupled to a packet-switched network;
execute a natural language processing operation on the input query data to generate analysis data comprising an intent classification and extracted semantic elements;
construct a constrained instruction sequence comprising the analysis data and output condition parameters specifying generation of an interrogative output, and input the constrained instruction sequence into a generative neural network model to acquire generated follow-up query data;
execute a post-processing operation on the generated follow-up query data comprising an interrogative sentence verification operation and a content filtering operation to produce validated presentation data; and
transmit the validated presentation data to the terminal device.

19. The system according to claim 18, wherein the circuitry is further configured to:
acquire subsequent input data from the terminal device, append the subsequent input data and the validated presentation data to a dialogue history, and construct a subsequent constrained instruction sequence incorporating the dialogue history to implement an iterative dialogue loop.

20. A method comprising:
acquiring, by circuitry via a communication interface coupled to a packet-switched network, input query data expressed in natural language from a terminal device;
executing a natural language processing operation on the input query data, the natural language processing operation comprising morphological analysis, syntactic parsing, and contextual interpretation, to generate analysis data comprising an intent classification and extracted semantic elements of the input query data;
constructing a constrained instruction sequence based on the analysis data, the constrained instruction sequence comprising the intent classification, the extracted semantic elements, operation condition parameters, and output condition parameters specifying that a generative neural network model is to generate an interrogative output that addresses underlying reasoning related to the input query data without providing a direct answer;
inputting the constrained instruction sequence into the generative neural network model comprising a transformer-based architecture and acquiring generated follow-up query data from the generative neural network model;
executing a post-processing operation on the generated follow-up query data, the post-processing operation comprising an interrogative sentence verification operation, a format normalization operation, and a content filtering operation, to produce validated presentation data; and
transmitting the validated presentation data to the terminal device via the communication interface.
